(19) United States
(12) Patent Application Publication
(10) Pub. No.: US 2013/0070052 A1
(43) Pub. Date: Mar. 21, 2013

(54) VIDEO PROCESING DEVICE, SYSTEM, VIDEO PROCESSING METHOD, AND VIDEO PROCESSING PROGRAM CAPABLE OF CHANGING DEPTH OF STEREOSCOPIC VIDEO IMAGES

(71) Applicants: Ken Yamashita, Nara (JP); Osamu Yamaji, Osaka (JP); Hidetaka Oto, Osaka (JP)

(72) Inventors: Ken Yamashita, Nara (JP); Osamu Yamaji, Osaka (JP); Hidetaka Oto, Osaka (JP)

(73) Assignee: PANASONIC CORPORATION, Osaka (JP)

(21) Appl. No.: 13/576,493

(22) PCT Filed: Mar. 28, 2012
(86) PCT No.: PCT/JP12/02143

§ 371 Date: Aug. 1, 2012

(30) Foreign Application Priority Data
Mar. 31, 2011 (JP) 2011-079004

(51) Int. Cl. H04N 13/00

(52) U.S. Cl. CPC H04N 13/0059
USPC 348/43

(57) ABSTRACT

A video processing device is one of multiple devices in a home theater system. Upon connection to another device, a depth adjustment determination module determines whether depth adjustment of two or more view components is necessary for playback of stereoscopic video images. When depth adjustment is necessary, a capability comparison module performs a communications sequence to determine which device will perform the depth adjustment. When it is determined during the communications sequence that the video processing device itself is to perform the depth adjustment, it does so and then transmits the resulting adjusted two or more view components to the other device. When it is determined that the other device is to perform the depth adjustment, the video processing device transmits the two or more view components without performing depth adjustment.

### TECHNICAL FIELD

The present invention belongs to the field of technology for adjusting depth of stereoscopic video images.

### BACKGROUND ART

Technology for adjusting the depth of stereoscopic video images is used when displaying and reproducing stereoscopic video images, constituted by two or more view components, on a screen of a different size than the screen on which the stereoscopic video images were intended to be displayed when created. This technology adapts the stereoscopic video images to the other screen by adjusting the parallax between the two or more view components. Depth adjustment is well-known technology, as disclosed in Patent Literature 1 and 2. The depth adjustment disclosed in Patent Literature 1 moves objects forwards or backwards by shifting the entire left-view and right-view video images horizontally in opposite directions. The depth adjustment in Patent Literature 2 generates a virtual perspective, whereby the amount of parallax differs for each object in the stereoscopic video images. This results in a greater or lesser sense of depth. When changing the depth based on a parallax map as in the method of Patent Literature 2, the video images in the generated virtual perspective depend on the accuracy of the parallax map.

### CITATION LIST

### Patent Literature

Patent Literature 1: Japanese Patent Application Publication No. 2005-73049

Patent Literature 2: Japanese Patent Application Publication No. 2003-209858

### Non-Patent Literature

Non-Patent Literature 1: Kurt Konolige, “Small Vision Systems: Hardware and Implementation”, Artificial Intelligence Center, SRI International

Non-Patent Literature 2: Heiko Hirschmüller, “Accurate and Efficient Stereo Processing by Semi-Global Matching and Mutual Information”, Institute of Robotics and Mechatronics Oberpfaffenhofen German Aerospace Center (DLR), June, 2005

Non-Patent Literature 3: Vladimir Kolmogorov, “GRAPH BASED ALGORITHMS FOR SCENE RECONSTRUCTION FROM TWO OR MORE VIEWS”, the Graduate School of Cornell University, January 2004

### SUMMARY OF INVENTION

### Technical Problem

In recent years, the tendency in the above technical field has been towards inter-device transfer of stereoscopic video images by connecting a device that supplies a stream to a device for display. This leads to a form of viewing in which stereoscopic video images are played back across a plurality of devices. For example, a content recorded on a BD recorder may be loaded into and displayed on a household device with a large display, a car navigation device, or a portable player. Instead of loading the content, data may also be displayed after being transferred to another device by wired or wireless communication.

During inter-device transfer, when the device that supplies the stream and the device for display connect, it becomes necessary for the device for display to adjust the depth of the stereoscopic video images. The basic approach in this case is to have the device that displays video images adjust the depth.

Since the display device has a certain screen size, depth adjustment is unnecessary in some cases yet is necessary in others. Furthermore, display devices differ in that some have a high capability for depth adjustment, while others have a low capability. Similarly, devices that provide the stream differ in that some have a high capability for depth adjustment, while others have a low capability. Depth adjustment technology is typically the technology disclosed in Patent Literature 2. With the depth adjustment technology in Patent Literature 2, the video images in the generated virtual perspective depend on the accuracy of the parallax map. Therefore, the degree of accuracy in creating the parallax map greatly influences the quality of the stereoscopic video images. In other words, when using the depth adjustment technology in Patent Literature 2, the quality of the stereoscopic view differs greatly depending on the degree of accuracy in creating the parallax map. Therefore, differences in the depth adjustment capability of the devices result in a greatly exaggerated difference in stereoscopic display capability.

Whether depth adjustment is necessary or not depends on the screen size of the device, and furthermore, depth adjustment capability differs by device. Therefore, if images are transmitted without any depth adjustment, with the firm assumption that the display device will perform depth adjustment, it may be the case that the display device is unable to appropriately adjust the depth, resulting in inappropriate stereoscopic display.

On the other hand, if the device that transmits the stream always performs depth adjustment, then if the display device that receives the data transmission has a higher capability for depth adjustment, stereoscopic playback may be performed with insufficient depth adjustment, despite the display device being able to perform appropriate depth adjustment. Another problem is that if playback devices are required to have a high capability for depth adjustment under the assumption that all devices that will be connected thereto will have a low capability, the cost of the playback devices will escalate.

Thus far, technical problems have been discussed under the assumption that a device providing a stream is connected to a device that is for display. This assumption has simply been chosen, however, to provide a familiar example for the sake of explaining the above technical problems. The technical problems addressed by the present application are not limited to the case of when a device providing a stream is connected to a device that is for display.

The technical problem to be addressed by the present application is the resolution of any inconformity occurring when video processing devices connect to each other and perform inter-device transfer, the video processing devices each performing some sort of processing on two or more view components that constitute stereoscopic video images. This technical problem is a barrier that practitioners will necessarily face in the near future when the above technology is put into practical use in manufactured products.

It is an object of the present invention to provide a video processing device capable of displaying high-quality stereoscopic video images in the context of inter-device transfer of two or more view components without the need for all devices to have a high capability for depth adjustment.

### Solution to Problem

A device that can resolve such a problem is a video processing device for transmission and reception of two or more view components and for depth adjustment of stereoscopic video images constituted by the two or more view components, the video processing device comprising:

an inter-device interface configured to connect to a target device with which to perform the transmission and reception of the two or more view components;

a determination unit configured to determine, through performance of a predetermined communications sequence with the target device, which of the video processing device and the target device is to perform the depth adjustment; and
a processing unit configured to perform the depth adjustment, when the determination unit determines that the video processing device is to perform the depth adjustment, on two or more received view components or on two or more view components to be transmitted, wherein
the depth adjustment includes searching for matching pixels that match pixels in a first view component, the matching pixels being included in a second view component, and detecting parallax between the pixels in the first view component and the matching pixels in the second view component, and
the communications sequence includes a transfer phase for transmission and receipt, between the video processing device and the target device, of capability information indicating a search capability for the matching pixels, and a comparison phase for comparing the search capability of the video processing device and the search capability of the target device.

### Advantageous Effects of Invention

When connected to another device, the video processing device performs a transmission sequence to determine the device that is to perform depth adjustment. The device with a higher capability becomes the device to perform the depth adjustment, thereby avoiding the bad case of the device with a lower capability of searching for matching pixels performing depth adjustment and the other device displaying the result of such depth adjustment.

When two devices are connected, the two or more view components are transferred after deciding on which device performs the depth adjustment. Therefore, if a user has already purchased a display device with a high depth adjustment ability, the user need not also purchase a playback device with a high depth adjustment ability. Automatically determining the device that is to perform depth adjustment depending on the other device with which the video processing device exchanges data allows for selection of a playback device with high depth adjustment and a display device with low depth adjustment, or allows for smarter purchasing whereby, upon selecting a display device with a high capability, a buyer can choose to purchase a playback device with a low capability. The above structure thus contributes to the further expansion of stereoscopic playback environments.

When determining to perform the depth adjustment, the video processing device transfers the stream as is to the other device. Therefore, the device with the lower adjustment capability will never perform the depth adjustment.

While optional, the depth adjustment may further include generating generating a depth image based on the detected parallax, adjusting the depth image in accordance with a screen on which the two or more view components are to be displayed, and performing depth image based rendering, based on the adjusted depth image, on the first view component to obtain two or more view components with an adjusted parallax. Depth adjustment processing can be implemented as an extension of software and hardware processing to perform depth image based rendering, thus fostering the commercialization of video processing devices. Furthermore, when the amount of parallax between the left-view images and right-view images has been set to be appropriate for display of two or more view components on a 50-inch screen, the left-view images and right-view images can be regenerated so as to be appropriate for display on a larger or a smaller screen.

### BRIEF DESCRIPTION OF DRAWINGS

FIG. 1 illustrates an embodiment of a home theater system composed of two or more video processing devices.

FIG. 2 illustrates the internal structure of a device, among the devices in FIG. 1, that transmits a stream (playback device 100).

FIG. 3 illustrates the internal structure of devices, among the devices in FIG. 1, that are for display (television 200, television 300).

FIGS. 4A and 4B illustrate depth when objects jump out of or are behind the screen.

FIG. 5 illustrates the depth amount for each of the television 200 through the mobile terminal 400 illustrated in FIG. 1.

FIGS. 6A through 6D compare two theoretical screens.

FIG. 7 schematically illustrates a parallax map.

FIG. 8 illustrates the processing by the depth generator 10 as applied to actual images.

FIG. 9 illustrates the processing by the DIBR unit 12 as applied to actual images.

FIGS. 10A through 10C illustrate the jump-forward amount of stereoscopic video images when the depth adjustment is performed as in FIG. 9.

FIGS. 11A through 11C illustrate the way in which the depth represented by the depth map changes depending on the matching point search algorithm.

FIGS. 12A through 12C illustrate a matching point search with block matching, semi-global matching, and a graph cut.

FIGS. 13A and 13B illustrate a communications sequence.

FIGS. 14A through 14D illustrate example settings of capability information for the playback device 100, the television 200, the television 300, and the mobile terminal 400 illustrated in FIG. 1.

FIGS. 15A and 15B illustrate examples of response information.

FIGS. 16A and 16B illustrate examples of response information.

FIGS. 17A and 17B illustrate variations on device connection and the video image displayed during such connection.

FIGS. 18A and 18B illustrate variations on device connection and the video image displayed during such connection.

FIG. 19 is a main flowchart of processing steps for depth device determination.

FIGS. 20A and 20B are flowcharts illustrating processing steps for the determination of whether depth adjustment is necessary for content and the processing steps for device negotiations.

FIG. 21 is a flowchart illustrating steps for exchanging device capability.

FIG. 22 is a flowchart illustrating steps for selecting the device that is to perform depth adjustment.

FIG. 23 is a flowchart illustrating processing steps for the depth adjustment.

FIG. 24 is a flowchart illustrating processing steps for parallax map creation.

FIG. 25 illustrates the internal structure of a video processing device that takes into consideration data other than a video stream.

### DESCRIPTION OF EMBODIMENTS

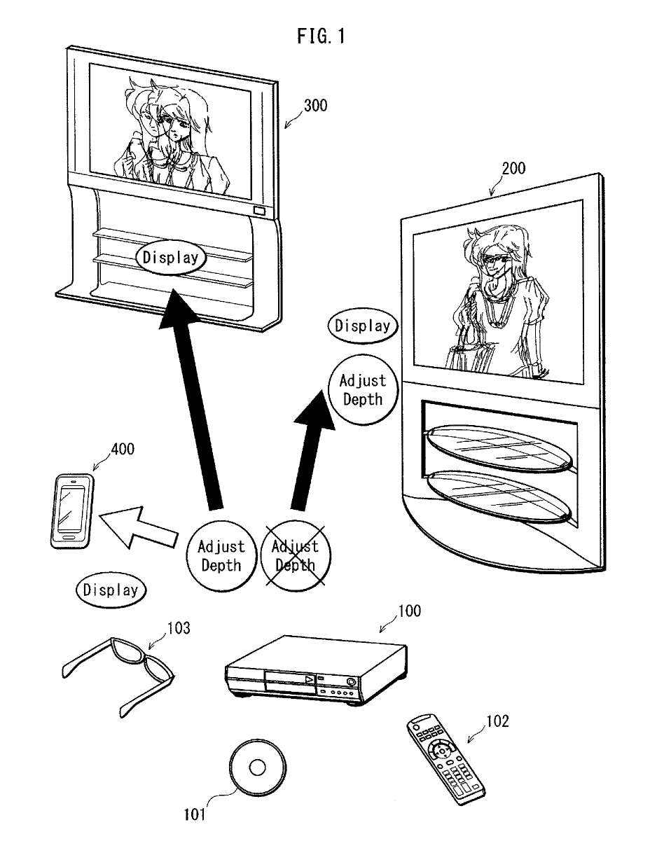

A video processing device provided with a means for solving the above problem according to the invention may be embodied as a player device, a television device, or a mobile terminal device, and an integrated circuit according to the invention may be embodied as a system LSI incorporated into these devices. The video processing method according to the invention may be embodied as chronological procedures implemented by these devices. The program according to the present invention may be embodied as an executable program recorded on a computer-readable recording medium and installed on these devices. FIG. 1 illustrates a home theater system formed by a playback device, a display device, and glasses. As illustrated in (a) of FIG. 1, the playback device, the display device, and a mobile terminal form a home theater system, along with glasses and a remote control, for use by a user.

Upon being connected to a large-size display 200, a medium-size television 300, or a mobile terminal 400, a playback device 100 plays back a content recorded on an optical disc 101 and causes the large-size display 200, the medium-size television 300, or the mobile terminal 400 to display the played back video on the display screen. When the video output by the playback device 100 corresponds to stereoscopic video images (also referred to as 3D video images), then stereoscopic video images are output on the display screen of the large-size display 200, the medium-size television 300, or the mobile terminal 400 connected to the playback device 100.

The optical disc 101 is a BD-ROM or a DVD-Video and is an example of a recording medium loaded into a playback device.

The remote control 102 receives user instructions and causes the playback device 100, the large-size display 200, or the medium-size display 300 to perform operations corresponding to the user instructions.

The large-size display 200 is a large-screen television, for example with a screen size of 70 inches, and has a stereoscopic video depth adjustment function.

The medium-size display 300 is a regular-screen television, for example with a screen size of 50 inches, and has a stereoscopic video depth adjustment function.

The mobile terminal 400 is a small display device, for example with a screen size of five inches. The mobile terminal 400 includes a stereoscopic photography unit, a writing unit, and a communications unit. The writing unit stores two or more view components obtained by photography in a stereoscopic photograph file and writes the file on a recording medium. The communications unit transmits and receives two or more view components. The mobile terminal 400 also has a function to play back stereoscopic video images and a stereoscopic video depth adjustment function.

The devices illustrated in FIG. 1 (specifically, the display screen of the playback device 100, the large-size display 200, the medium-size television 300, and the mobile terminal 400) all include a stereoscopic video depth adjustment function. Depending on the devices that are connected, however, only one of the devices is configured to perform stereoscopic video depth adjustment processing.

In the example in FIG. 1, the large-size display 200 generally has high-performance hardware and can be expected to perform stereoscopic display of stereoscopic video images received from the playback device 100 after adjustment to the depth corresponding to the screen size of the large-size display 200. Therefore, the large-size display 200 is caused to perform depth adjustment processing. On the other hand, as compared to the large-size display 200, the mobile terminal 400 often does not have as high-performance hardware. Causing the mobile terminal 400 to perform depth adjustment processing may place a high processing load on the mobile terminal 400, thereby running the risk of problems with stereoscopic video image display. Therefore, the playback device 100 is configured to output stereoscopic video images for display to the mobile terminal 400 after adjustment to the depth corresponding to the screen size of the mobile terminal 400.

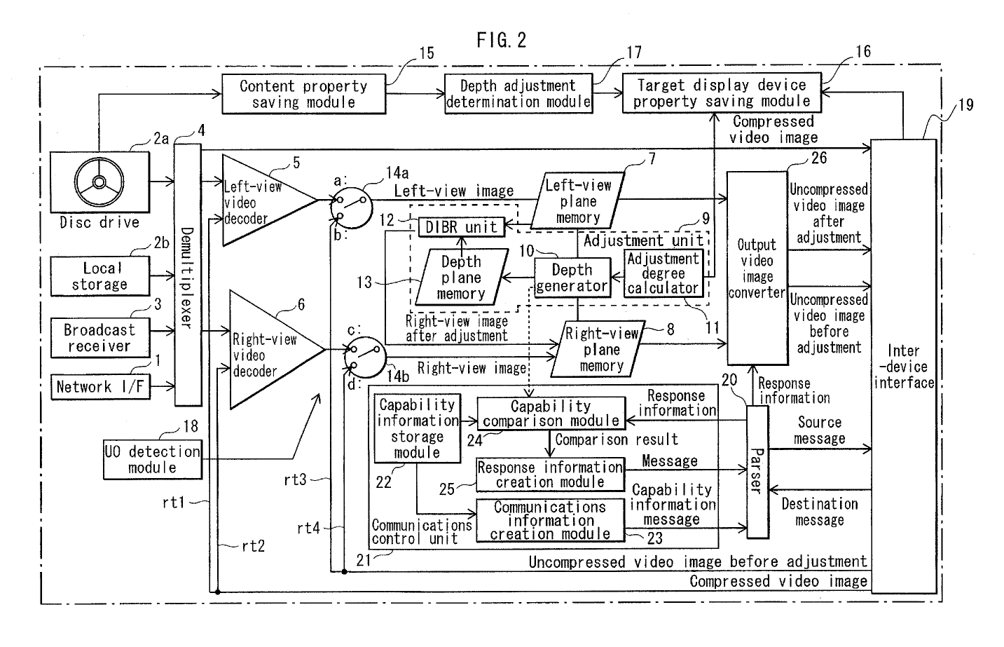

Among these devices in FIG. 1, the device that transmits the stream is the playback device 100. The television 200 and the television 300 can act as devices for display. The mobile terminal 400 can act as both a stream-transmitting device and a device for display. FIG. 2 illustrates the internal structure of a device, among the devices in FIG. 1, that transmits a stream (playback device 100). As illustrated in FIG. 2, the device that transmits the stream includes a network interface 1, a disc drive 2a, a local storage 2b, a broadcast receiver 3, a demultiplexer 4, a left-view image decoder 5, a right-view image decoder 6, a left-view plane memory 7, a right-view plane memory 8, an adjustment unit 9, a depth generator 10, an adjustment degree calculator 11, a depth image memory 12, a DIBR unit 13, switches 14a and 14b, a content property saving module 15, a target display device property saving module 16, a depth adjustment determination module 17, a UO detection module 18, a device interface 19, a parser 20, a communications control unit 21, a capability information storage module 22, a communications information creation module 23, a capability comparison module 24, and a response information creation module 25.

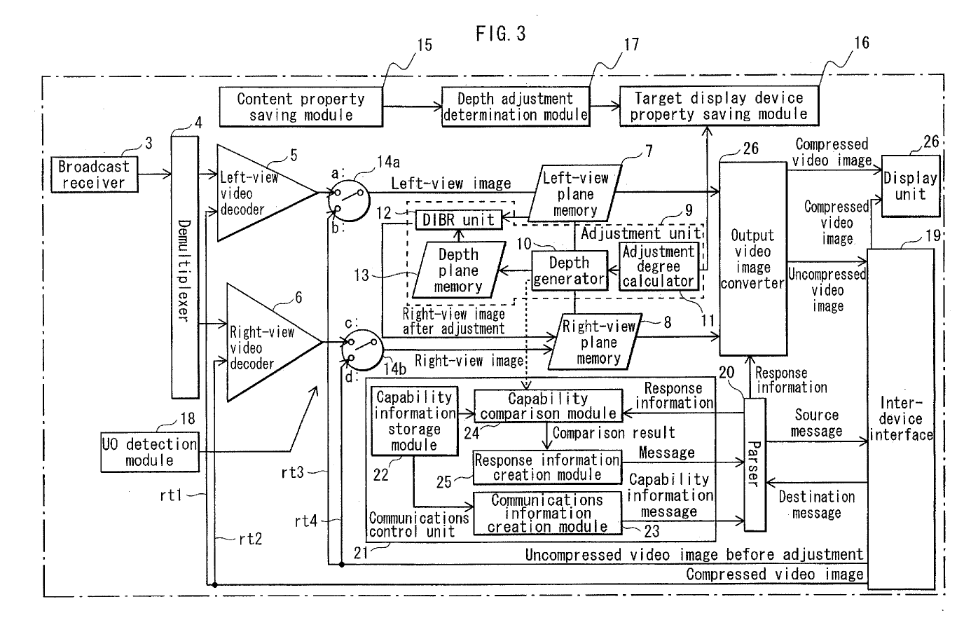

FIG. 3 illustrates the internal structure of devices, among the devices in FIG. 1, that are for display (television 200, television 300). FIG. 3 has been created based on FIG. 2. As compared with FIG. 2, FIG. 3 lacks the network interface 1, the optical disc drive 2a, and the local storage 2b, and additionally includes a display unit 26. The arrows among the internal structure in FIGS. 2 and 3 illustrate intermediate paths indicating the constituent elements of the figures through which image data passes.

Next, the characteristic constituent elements of the device that transmits the stream are described. Dividing these characteristic constituent elements up by function yields the following groups: “stream supply source”, “playback unit”, “depth adjustment”, “user input”, “inter-device connection”, and “screen adaptation”.

1. Stream Supply Source

The constituent elements classified into the “stream supply source” group are the network interface 1, the optical disc drive 2a, the local storage 2b, the broadcast receiver 3, and the demultiplexer 4. When the stereoscopic video images are moving images, a right-view stream and a left-view stream may be prepared separately. Alternatively, a right-view stream and a left-view stream may be embedded within one stream file. The present embodiment describes an example in which the right-view stream and the left-view stream are embedded in advance in one stream file. In this case, information for separating the left-view stream from the right-view stream is included in the header information for one stream. The following describes the constituent elements belonging to the stream supply source group.

The network interface 1 is a communications interface used for inter-device negotiation and for transfer of target playback content. The physical device corresponding to the network interface 1 is, for example, a wired/wireless LAN (Local Area Network) typically used around the world in homes and offices, or a device that can send and receive packets using TCP/UDP, using the BLUETOOTH™ wireless standard or the like.

The disc drive 2a loads/ejects a BD-ROM 100 and accesses the BD-ROM. Like a removable media, the BD-ROM 100 is a means used for exchanging a target playback content. If a different means for exchanging stereoscopic video images is provided, the device need not be provided with the disc drive 2a.

The local storage 2b is a storage medium inserted through an external slot (not shown in the figures). Desirable examples of a recording medium are a semiconductor memory or a magnetic recording medium, such as a secure memory card or a flash memory. The video processing device illustrated in FIG. 2 has an external slot (not shown in the figures) for inserting removable media. Once a removable memory is inserted in this external slot, the removable memory is accessed (read from / written to) via an interface (not shown in the figures) for removable memory access.

The broadcast receiver 3 acquires a transport stream from a broadcast and outputs the transport stream to the demultiplexer 4.

The demultiplexer 4 separates the left-view video stream and the right-view video stream based on header information of the stream acquired via the network interface 1, the optical disc drive 2a, the local storage 2b, or the broadcast receiver 3. The demultiplexer 4 alternately demultiplexes the left-view video stream and the right-view video stream, outputting the left-view video image and the right-view video image when both video images are complete. Depending on the output format, output may alternate. Furthermore, when video images are output twice due to the hardware configuration, left-view video images and right-view video images are output separately.

This concludes the description of the constituent elements belonging to the stream supply source group.

2. Playback Unit

The constituent elements classified into the “playback unit” group are the left-view image decoder 5, the right-view image decoder 6, the left-view plane memory 7, and the right-view plane memory 8. The following describes these constituent elements.

Left-View Image Decoder 5, Right-View Image Decoder 6

The left-view image decoder 5 decodes left-view image data.

The right-view image decoder 6 decodes right-view image data.

In addition to receiving the stream supplied by the demultiplexer 4, the left-view image decoder 5 has a path rt1 for receiving a supply of compressed left-view image data from the inter-device interface 19. This path rt1 assumes that input is passed through from the stream supply source of another device. Similarly, in addition to receiving the stream supplied by the demultiplexer 4, the right-view image decoder 6 has a path rt2 for receiving a supply of compressed left-view image data from the inter-device interface 19. This path rt2 also assumes that input is passed through from the stream supply source of another device.

Left-View Plane Memory 7

The left-view plane memory 7 stores uncompressed left-view image data obtained by the decoding performed by the left-view image decoder 5.

Right-View Plane Memory 8

The right-view plane memory 8 stores uncompressed right-view image data obtained by the decoding performed by the right-view image decoder 6.

3. Depth Adjustment

Depth adjustment is processing for actual adjustment of the depth of stereoscopic video images. The constituent elements classified into the “depth adjustment” group are the adjustment unit 9, the depth generator 10, the depth plane memory 11, the DIBR unit 12, the switch 13, the switch 14, the content property saving module 15, the target display device property saving module 16, and the depth adjustment determination module 17. The following describes the constituent elements for achieving depth adjustment.

Adjustment Unit 9

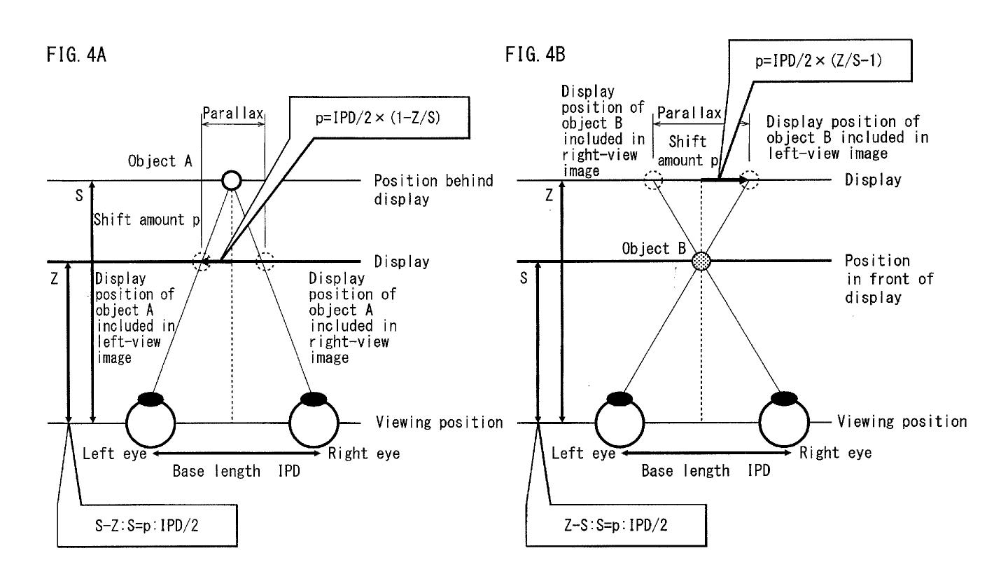

The adjustment unit 9 includes the depth generator 10, the depth plane memory 11, and the DIBR unit 12 and adjusts the parallax between a left-view image and a right-view image. Before describing the depth generator 10, the depth plane memory 11, and the DIBR unit 12, the nature of depth adjustment processing is first described. Since the display position of an object A included in a left-view image differs from the position of the object A included in a right-view image, the display positions of course differ when shown on the display. The left-view image and the right-view image are displayed alternately over short time intervals, and by wearing shutter glasses, a viewer sees the left-view image in the left eye and the right-view image in the right eye. The adjusted depth thus appears to jump out of the screen or to be further behind the screen. FIGS. 4A and 4B illustrate depth when objects jump out of or are behind the screen.

A person's eyes always attempt to focus on objects. The eyes focus on object A in FIG. 4A at a position that is the intersection of a straight line connecting the left eye with object A in the left-view image and a straight line connecting the right eye with object A in the right-view image. As a result, the brain recognizes the object as being positioned further back than the display, so that the viewer perceives object A as being positioned further back than the display.

The amount by which the object appears to jump out of the display or be behind the display varies in accordance with the extent of this shift. Furthermore, whether an object in an image appears to jump out of or be behind the display is determined by the direction of the shift between the left and right-view images. In the case of large-screen content, such as a movie, the parallax between the left-right video images is small, i.e. the left and right-view images are created with a small shift. On the other hand, in the case of small-screen content, such as images captured by an image pickup apparatus or a portable terminal, the parallax between the left-right video images is large, i.e. the left and right-view images are created with a large shift. This allows for creation and playback of stereoscopic video images with a sufficiently stereoscopic feel that reduce eyestrain experienced by the viewer.

The following describes the degree to which the object in FIG. 4A appears to be behind the screen. Letting the distance from the viewing position to the display be Z, the distance from the viewing position to the object be S, the width (base length) between the eyes be IPD, an object A that appears to be behind the display be projected on the display, and p be a shift amount of the left-view image along the horizontal direction of the display, equal to the distance between the object A projected on the display and the object A included in the left-view image, then Equation 1 below holds.

P=(IPD/2)×(1−Z/S) Equation 1

In FIGS. 4A and 4B, the ratio between the distance Z to the display and the distance S to the jump-forward position represents the depth. The distance Z to the display is set to three times the width of the screen.

The following describes the degree to which the object in FIG. 4B appears to jump forward from the display. Letting the distance from the viewing position to the display be Z, the distance from the viewing position to the object be S, the width (base length) between the eyes be IPD, an object B that appears to jump forward from the display be projected on the display, and p be a shift amount of the left-view image along the horizontal direction of the display, equal to the distance between the object B projected on the display and the object B included in the left-view image, then Equation 2 below holds.

P=(IPD/2)×(Z/S−1) Equation 2

The parallax is the shift amount p in Equations 1 and 2 multiplied by two.

To account for the direction of the shift, however, it is necessary to take the positive or negative sign of the shift into consideration. In the case of large-screen content, such as a movie, the parallax between the left-right video images is small, i.e. the left and right-view images are created with a small shift. On the other hand, in the case of small-screen content, such as images captured by an image pickup apparatus or a portable terminal, the parallax between the left-right video images is large, i.e. the left and right-view images are created with a large shift. This allows for creation and playback of stereoscopic video images with a sufficiently stereoscopic feel that reduce eyestrain experienced by the viewer.

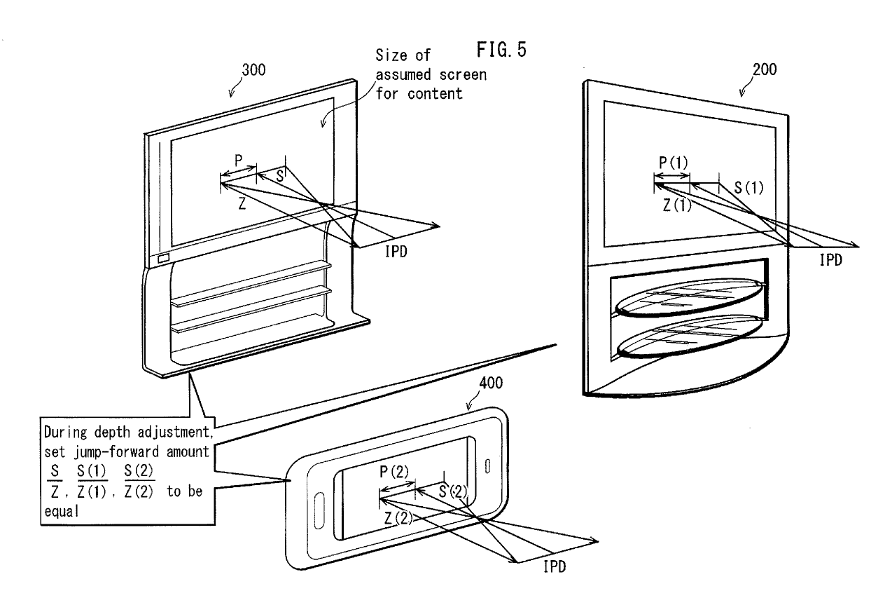

FIG. 5 illustrates depth adjustment. The depth amount differs between the plurality of devices illustrated in FIG. 1, since the size of each screen in inches differs. FIG. 5 illustrates the depth amount for each of the television 200 through the mobile terminal 400 illustrated in FIG. 1. In addition to the external appearance of the television 200 through the mobile terminal 400, FIG. 5 includes the parameters stipulating the depth amount illustrated in FIGS. 4A and 4B. The television 300 is a display for which a content producer has set an assumed screen for content. An assumed screen for content is a screen on which it is assumed that stereoscopic content will be played back. In many cases, it is assumed that stereoscopic movie content will be played back on a 50-inch display device. Therefore, the size of the assumed screen for content becomes 50 inches. On the other hand, stereoscopic photographs captured with a 3D camera for personal use are assumed to be displayed on a smaller screen. Therefore, this smaller screen becomes the size of the assumed screen for content.

The assumed screen for content is at a position Z from the user's face, and video images appear at a jump-forward position of S due to the stereoscopic effect. The television 200 is a larger screen than the assumed screen for content, and the screen is positioned at Z(1). Video images appear at a jump-forward position of S(1) due to the stereoscopic effect. The mobile terminal 400 is a smaller screen than the assumed screen for content, and the screen is positioned at Z(2). Video images appear at a jump-forward position of S(2) due to the stereoscopic effect. Despite the differences in size of these screens, it suffices to establish the parallax on the screen so as to satisfy the relationship Z/S=Z(1)/S(1)=Z(2)/S(2) in order to maintain a constant ratio between the depth position of the screen and the jump-forward position.

The depth amount of the television 300 is expressed here as S/Z. Therefore, the depth amount is S(1)/Z(1) for the television 200 and S(2)/Z(2) for the mobile terminal 400. Since the sizes of the television 200 and the mobile terminal 400 differ, the depth amounts also differ. In order to standardize these depth amounts between a plurality of devices, it is necessary to adjust the shift amounts Ps(1) and Ps(2) on the screen. The following describes an adjustment rate Mrate.

The adjustment rate Mrate calculates an appropriate parallax for the screen on which images are to be displayed, using a constant ratio for the above Z and S. Therefore, the adjustment rate Mrate needs to be set in accordance with the ratio between the parallax determined using the original dimensions of the assumed screen for content and the parallax determined using the original dimensions of the screen (x) on which images are to be displayed. In other words, the adjustment rate Mrate is the ratio between the shift amount Ps in the assumed screen for content and the shift amount Ps(x) in the screen x of an arbitrary size.

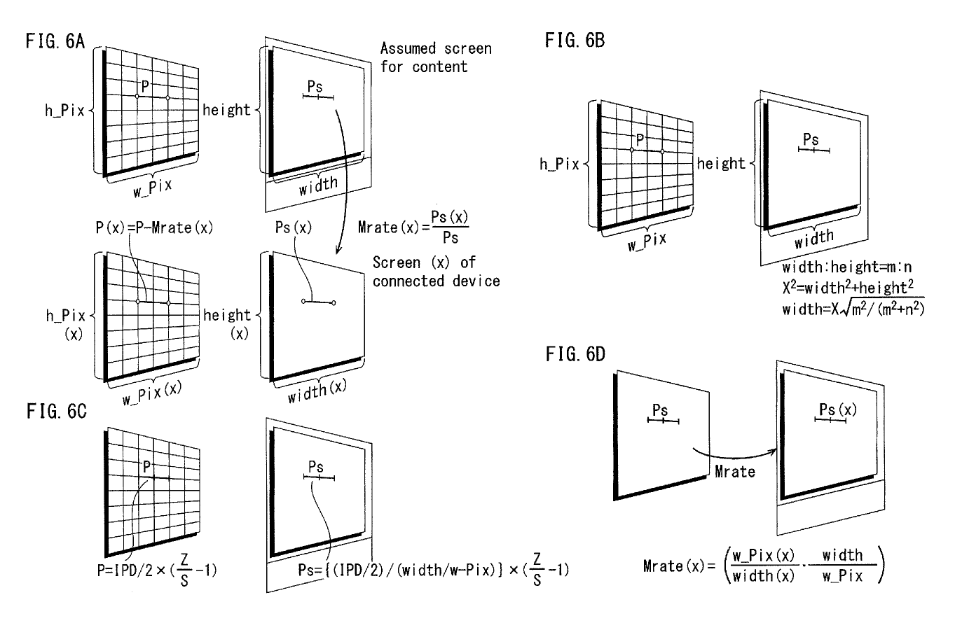

FIGS. 6A through 6D compare two theoretical screens. One of the theoretical screens is determined by the vertical number of pixels and the horizontal number of pixels (w_pix by h_pix). The other screen is determined by the actual original dimensions of width and height (width by height in mm).

FIG. 6A compares the assumed screen for content with a target display screen (x). The upper portion of FIG. 6A is the assumed screen for content, and illustrates the screen determined by the vertical number of pixels and the horizontal number of pixels in overlap with the screen determined by the actual original dimensions of width and height. The lower portion of FIG. 6A is the target display screen (x), and illustrates the screen determined by the vertical number of pixels and the horizontal number of pixels in overlap with the screen determined by the actual original dimensions of width and height. In FIG. 6A, the adjustment rate Mrate is calculated based on the ratio between the shift amount Ps in the assumed screen for content and the shift amount Ps(x) in the target display screen (x). The shift amount P(x) that is necessary for the target display screen (x) thus becomes the shift amount P in the assumed screen for content multiplied by the adjustment rate Mrate. Thus calculating the adjustment rate Mrate and multiplying it by the shift amount P in the screen determined by the vertical number of pixels and the horizontal number of pixels yields the shift amount P(x) appropriate for the target display screen (x). Doubling this pixel shift amount yields the parallax.

FIG. 6B illustrates how to calculate the width and the height. The ratio between the width and the height is m:n. Letting X squared be the sum of the width squared and the height squared, the width is determined by the equation in FIG. 6B with the Ai sign. FIG. 6C contrasts the difference between the parallax P determined by the number of pixels (P=(IPD/2)×(Z/S−1)) and the parallax Ps determined by the original dimensions (Ps=((IPD/2)/(width/w_pix))×(Z/S−1)).

If the parallax in the target display screen (x) is Ps(x), then the adjustment rate Mrate(x) for adapting the parallax p determined by the number of pixels in the assumed screen for content to the target display screen (x) is Ps(x)/Ps. Accordingly, the adjustment rate Mrate is calculated as the ratio Ps(x)/Ps between the actual parallax Ps in the assumed screen for content and the parallax P(x) in the target display screen (x).

When expressing the adjustment rate Mrate in terms of the width(x) and w_pix(x) in the target display screen (x), the adjustment rate Mrate is represented by the equation in FIG. 6D, (w_pix(x)/width(x)·width/w_pix). The following describes how much the shift amount differs when displaying images on a 50-inch display and when displaying images on a five-inch display. Typically, the base length IPD is 6.5 cm. In a 50-inch display, supposing that an object is to jump forward by 10%, the shift amount in an image on the 50-inch display would be six pixels. By contrast, a shift amount of 63 pixels would be necessary on a five-inch display. This concludes the description of the adjustment rate.

Depth Generator 10

The depth generation unit 10 takes a pixel group in an image from one view and searches for a matching pixel group that matches the pixel group in an image from another view, detects the parallax between the pixel group in the image from one view and the matching pixel group in the image from the other view, and uses this parallax to generate map information that serves as the basis for depth adjustment. The map information that serves as the basis for depth adjustment may be a parallax map or a depth image. A parallax map is map information indicating how many pixels the left and right-view images differ by, whereas a depth image is an image obtained by indicating how far objects are from a certain perspective. Since a parallax map and a depth image are interchangeable in Equation 2, they are considered equivalent. In a depth image, depth is represented by values of pixels constituting the image. The depth of objects in the depth image can be adjusted by making the luminance of the pixels in the depth image brighter or darker.

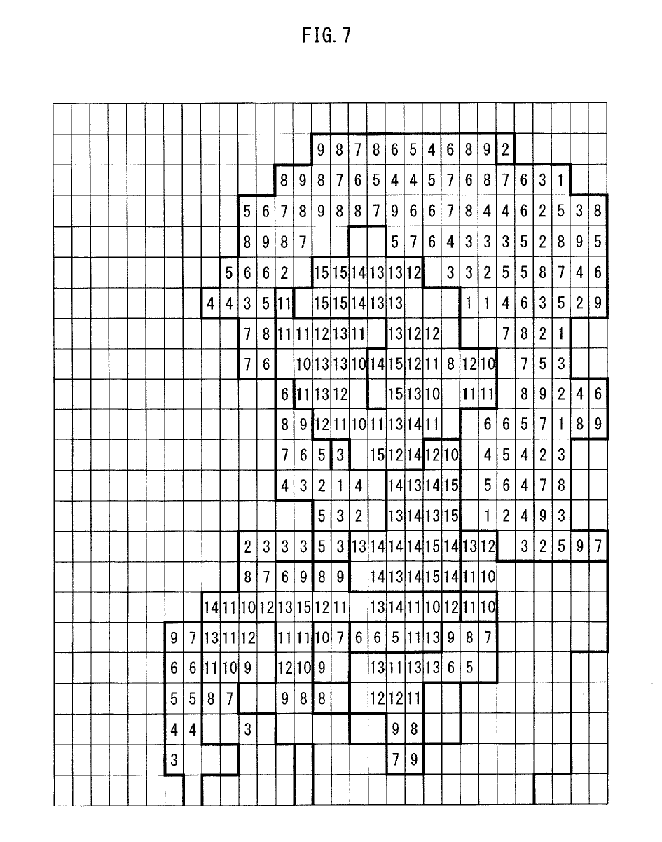

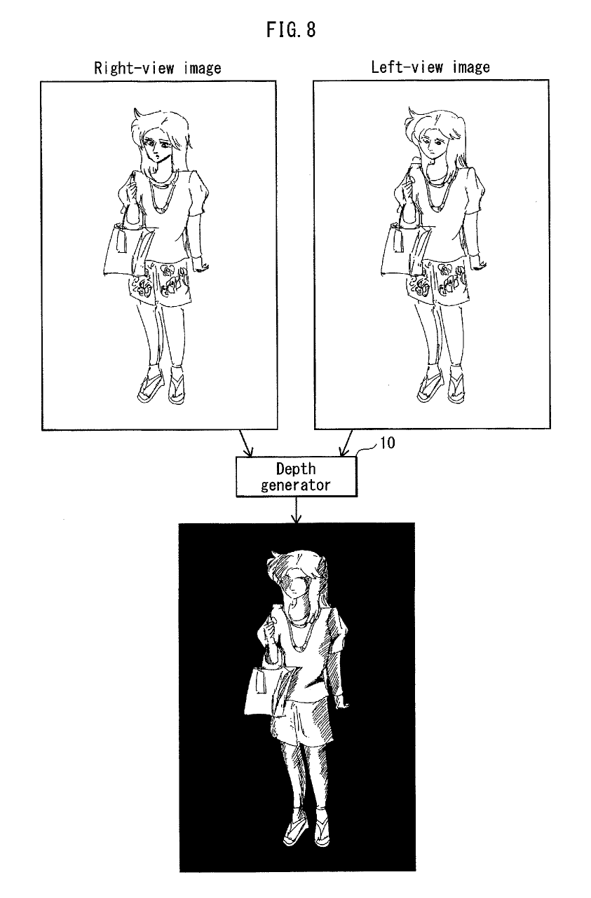

FIG. 7 schematically illustrates a parallax map. The parallax map in FIG. 7 corresponds to a left-view image of a person. The rectangles in FIG. 7 represent groups of rectangular pixels in the left-view image. The number in each rectangle represents a pixel group in the right-view image and indicates the parallax with the corresponding pixel group in the left-view image. In FIG. 7, the parallax is represented between the left-view image and the right-view image in a range of 1 to 15 pixels. The parallax is thus represented to a high degree of precision. After retrieving the parallax between the left-view image and the right-view image, the depth generator 10 creates a depth image representing the retrieved parallax for each pixel region. Subsequently, the depth generator 10 adapts the depth image to the display screen by multiplying each parallax by the adjustment rate, which corresponds to the screen size of the display. The final depth image is obtained by converting the parallax for each pixel in the adapted depth image into a depth. FIG. 8 illustrates the processing by the depth generator 10 as applied to actual images. In FIG. 8, the depth generator 10 is shown separated from the related constituent elements. FIG. 8 includes the flow of data. To the upper left of FIG. 8 is the left-view image stored in the left-view plane memory, and to the upper right is the right-view image stored in the right-view plane memory. The depth image generator is shown in the middle of FIG. 8, and the depth image is shown towards the bottom. Note that the depth image in FIG. 8 is drawn schematically. In the actual depth image, the outline of clothing, of the face, etc. would not appear as a black line. The actual depth image would be a white silhouette on a black background, with stereoscopic portions having a grey outline. The diagonal lines in FIG. 8 symbolically indicate how stereoscopic portions are represented with a grey outline in depth images.

Adjustment Degree Calculator 11

The adjustment degree calculator 11 calculates the adjustment rate from the equation (w_pix(x)/width(x)·width/w_pix) and stores the result. This adjustment rate is multiplied by the parallax detected during a matching point search. Multiplying the parallax detecting during the matching point search by the adjustment rate yields a new depth image.

Depth Image Memory 12

The depth image memory 12 stores depth images generated by the depth generator 10.

DIBR Unit 13

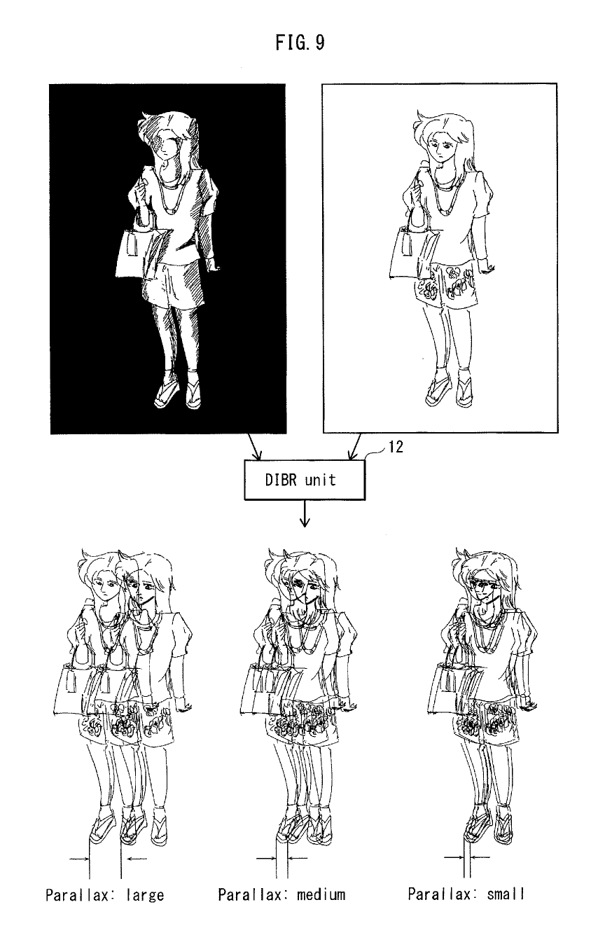

The DIBR unit 13 applies depth image based rendering (DIBR) based on the depth image that has been adjusted using the adjustment rate. The DIBR unit 13 applies DIBR to a left-view image, which is a video image from one view, to yield video images from two or more views with a corrected parallax. FIG. 9 illustrates the processing by the DIBR unit 12 as applied to actual images. To the upper left is a depth image, and to the upper right is a left-view image stored in the plane memory. The DIBR is shown in the middle, and three stereoscopic video images are shown towards the bottom. At the bottom left is a stereoscopic video image with a large parallax. In the middle towards the bottom is a stereoscopic video image with a medium parallax. At the bottom right is a stereoscopic video image with a small parallax. When stereoscopic content recorded on an optical disk is assumed to be played back on a 50-inch screen, the parallax is set to be large as described above if the display screen is a five-inch screen. Conversely, if the display screen is a 70-inch screen, the parallax is set to be small, as described above. Note that like FIG. 8, the depth image in FIG. 9 is drawn schematically. In the actual depth image, the outline of clothing, of the face, etc. would not appear as a black line. The depth image would be a white silhouette on a black background, with stereoscopic portions having a grey outline.

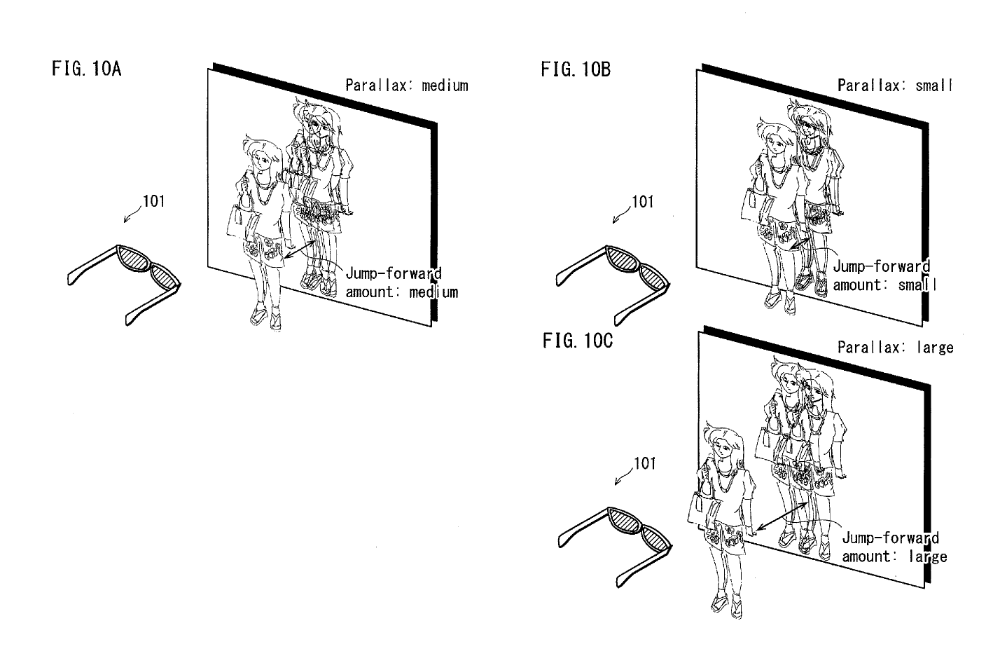

FIGS. 10A through 10C illustrate the jump-forward amount of stereoscopic video images when the depth adjustment is performed as in FIG. 9. FIG. 10A illustrates how much the stereoscopic video image jumps forward from the screen when the parallax is set to a large value. FIG. 10B illustrates how much the stereoscopic video image jumps forward from the screen when the parallax is set to an intermediate value. FIG. 10C illustrates how much the stereoscopic video image jumps forward from the screen when the parallax is set to a small value.

In the above description, it is assumed that the depth generator 10 creates a depth image that accurately reproduces the depth of objects. Generation of a depth image depends greatly, however, on the accuracy of searching for matching points. Differences in searching capability greatly affect the quality of the stereoscopic video images.

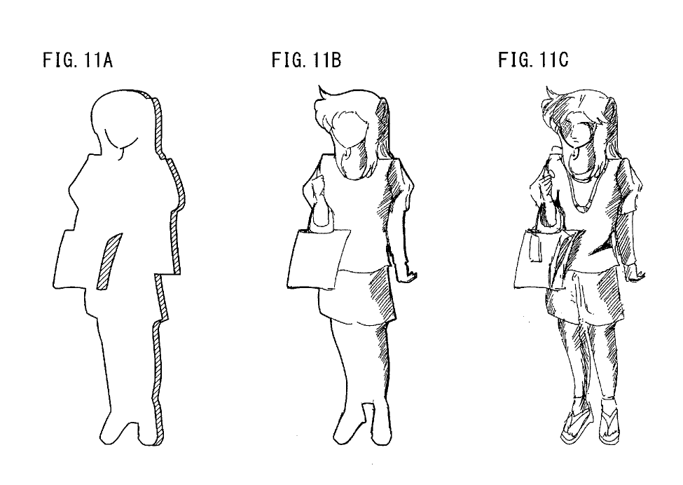

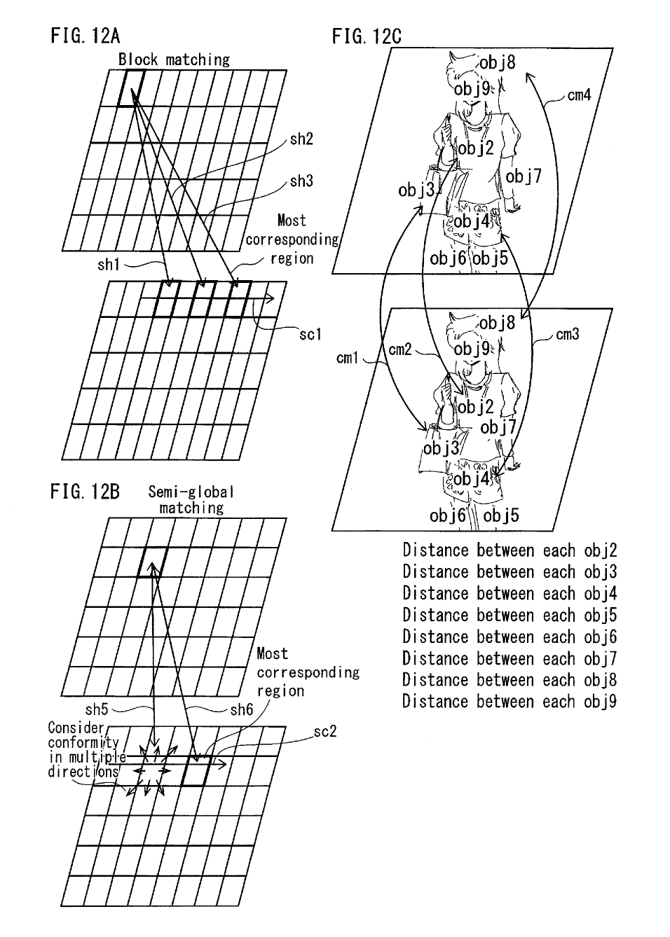

A crucial element during generation of the depth images is the matching point search, which examines the distance between a left-view region and the most closely conforming right-view region. The basic principle behind the matching point search is crucial. Therefore, in addition to the above description of the internal structure, details are also provided on the matching point search with reference to FIGS. 11A through 12C. The following is a detailed description with reference to these figures.

The way in which a matching point search is performed is now described.

FIGS. 11A through 11C illustrate the way in which the depth represented by the depth map changes depending on the matching point search algorithm. FIG. 11A is a depth image obtained using the matching point search with the lowest accuracy. In this case, the depth shown in the depth map of FIG. 11A is flat, showing only a slight projection as compared to the background image. The reason why the accuracy of the depth image is low is that the parallax at the matching point was nearly the same value for every region.

FIG. 11B is a depth image obtained using the matching point search with a medium level of accuracy. In FIG. 11B, the parallax at the matching points was detected with some degree of accuracy. Therefore, the depth in the depth image generated as a result of the matching point search is curved. By contrast, FIG. 11C faithfully recreates the depth of the person. The following describes these algorithms.

Among the generated depth images in FIGS. 11A, 11B, and 11C, which image is the most accurate depends on whether the algorithm used for adjustment is block matching, semi-global matching, or a graph cut, and on the extent of the search range. Accordingly, the search algorithm used in each device is listed as a property. In the present application, representative search algorithms are considered to be block matching, semi-global matching, and a graph cut. The following describes these search algorithms.

a. Block Matching

Block matching is an algorithm to divide the video image for one view into a plurality of regions and, for each region, to extract the region with the smallest difference in pixel value from the video image for the other view. More specifically, each divided region in the video image for the one view is set to the same region in the video image for the other view (referred to as a “corresponding region”). At this point, the position in the vertical direction of each divided region in the video image for the one view is considered to be the same as the position in the vertical direction of each region in the video image for the other view. The difference between the value of the pixels included in the divided region in the video image for the one view and the value of the pixels included in the corresponding region set in the video image for the other view is calculated. Next, the horizontal position of the corresponding region is shifted in the horizontal direction, and the difference in pixels is similarly calculated. In this way, the corresponding region is searched for in the horizontal direction, and the corresponding region with the smallest difference is considered the most corresponding region. The difference between the horizontal position of the most corresponding region and the horizontal position of the divided region in the video image of the one view is treated as the distance from the most corresponding region, and the distance to the most corresponding region is represented as depth by creating a parallax map (see Non-Patent Literature 1). FIG. 12A illustrates a matching point search with block matching. The arrows sh1, sh2, and sh3 indicate comparisons of pixel values between regions in the right-view image and regions in the left-view image. The arrow sc1 in the horizontal direction indicates horizontal scanning in the right-view image. The most corresponding region is found through this comparison and scanning.

b. Semi-Global Matching

Semi-global matching is an algorithm to search for corresponding regions horizontally while considering conformity between a plurality of adjacent regions, and to map the distance from the most corresponding region (see Non-Patent Literature 2).

FIG. 12B illustrates searching with semi-global matching. The arrows sh5, and sh6 indicate comparisons of pixel values between regions in the right-view image and regions in the left-view image. The arrows pointing in eight directions indicate comparison of conformity in eight directions. The arrow sc2 in the horizontal direction indicates horizontal scanning in the right-view image. The most corresponding region is found through this comparison and scanning.

c. Graph Cut

A graph cut is an algorithm to divide video images up by object and to map the distance between divided regions.

FIG. 12C schematically illustrates searching with a graph cut. In FIG. 12C, when the target of the search is the person in FIG. 8, the objects obj2, obj3, obj4, and obj5 are recognized through image recognition as human body parts, such as the torso, face, arms, and legs. Matching point search is performed for each of these objects. The arrows cm1, cm2, cm3, and cm4 indicate comparisons of pixel values between regions in the right-view image and regions in the left-view image. In the graph cut, image recognition is performed first, thus improving the accuracy of searching for matching points. This concludes the description of the search algorithms.

Switch 14a

The switch 14a switches the input of image data that is to be written to the left-view plane memory 7. When the switch element is set to setting a, uncompressed left-view image data obtained as a result of the decoding by the left-view image decoder 5 is stored in the left-view plane memory 7. When the switch element is set to setting b, uncompressed left-view image data transferred from another device via the inter-device interface 19 is stored in the left-view plane memory 7. As a result, both the uncompressed left-view image obtained as a result of the decoding by the left-view image decoder 5 and the uncompressed left-view image transferred from another device are the target of depth adjustment. The path rt3 is for storing, in the left-view plane memory 7, the input left-view image that is passed through from the stream supply source of another device.

Switch 14b

The switch 14b switches the input of image data that is to be written to the right-view plane memory 8. When the switch element is set to setting c, uncompressed right-view image data obtained as a result of the decoding by the right-view image decoder 6 is stored in the right-view plane memory 8. When the switch element is set to setting d, uncompressed right-view image data transferred from another device via the inter-device interface 19 is stored in the right-view plane memory 8. As a result, both the uncompressed right-view image obtained as a result of the decoding by the right-view image decoder 5 and the uncompressed right-view image transferred from another device are the target of depth adjustment. The path rt4 is for storing, in the right-view plane memory 8, the input right-view image that is passed through from the stream supply source of another device.

Content Property Saving Module 15

The content property saving module 15 stores content properties indicating the assumed screen size for image data targeted for stereoscopic viewing. The content properties are, for example, the following: the resolution of video images corresponding to the content; information on whether the video images corresponding to the content are stereoscopic; information on whether the depth of the video images corresponding to the content has been adjusted, and if so, the degree of adjustment; the encoding format of the content (LR multiplexed stream/side-by-side/top-bottom); information on whether the depth has already been adjusted for playback target content; the degree to which depth adjustment has been performed; the resolution of the content; the assumed playback screen size for the content; and the like. These pieces of information are, for example, acquired from head information of the stream corresponding to the content.

Display Device Property Saving Module 16

The display device property saving module 16 is a control register for saving information on the capabilities of a device for display of stereoscopic video images. The display device properties are, for example, the resolution of the display screen of the display device; the size of the display screen of the display device; whether the display device is capable of stereoscopic display; whether the display device is capable of depth adjustment, and if so, how the current depth adjustment setting has been set by the user; the display format of the display device (frame sequential/side-by-side / top-bottom); and additionally, whether the display device is remote. The device for display is not necessarily the same device. For example, a remote device that has performed negotiations may be the device for display, or a device may of course receive video images from another device and display the video images. The target display device properties are acquired via the inter-device interface 19, for example. The target display device properties are acquired before reception of a request for playback of stereoscopic video images, for example upon the startup of the client device, or upon remote connection between the client device and the server device.

If the device that triggers playback of stereoscopic video images displays the stereoscopic video images, the device triggering playback is itself the target display device for which the properties are acquired. If the stereoscopic video images are not displayed on the device that triggers playback, the target display device is a device that is connected to the device that triggers playback of stereoscopic video images and that has a display function. If the device that triggers playback of stereoscopic video images is itself the target display device, the device sets the properties using information stored in advance in its storage unit (not shown in the figures), such as a hard disc or memory. If the target display device is remote, the display device property saving module 16 stores properties of the target display device acquired via a multimedia cable interface of the network interface 1 or the inter-device interface 19.

Depth Adjustment Determination Module 17

At the time of content playback, the depth adjustment determination module 17 determines whether depth adjustment is necessary by determining whether the screen size for display matches the screen size of the assumed screen for content.

The following describes why it is inevitably necessary to provide the depth adjustment determination module 17 in a video processing device. The need to determine whether depth adjustment is necessary arises for the following reason. On the BD-ROM, the left-view images and the right-view images constituting the stereoscopic video images exist in a transport stream on the BD-ROM. Therefore, stereoscopic video images with depth adjustment performed at the authoring side can be played back by decoding the left-view images and the right-view images. The parallax represented by the left-view images and the right-view images is set under the assumption that the left-view images and the right-view images will be played back on a 50-inch screen or the like. Therefore, if the screen for actual display is larger than the screen that was assumed during authoring, the images will jump forward an excessive amount, whereas if the screen is smaller, the images will not jump forward sufficiently. Therefore, depth adjustment is performed so that the jump-forward amount is optimal for the actual display screen.

The determination of whether depth adjustment is necessary is made by direct comparison of screen size; sufficient information cannot be obtained, however, on the screen size for which it was assumed that the content to be played back would be played back. The current level of depth adjustment therefore becomes the criteria for making the determination. Specifically, the range of the parallax value for the left-view images and the right-view images whose depth has been adjusted depends on the size of the assumed screen for content. Therefore, if a device is provided with reference parallax values for a plurality of screen sizes for which it is assumed that playback will be performed, then by comparing the pre-stored reference values with the parallax between the left-view images and the right-view images, on which depth adjustment has been performed, the device can determine the screen size assumed for the content constituted by the left-view images and the right-view images. Thus detecting the size of the assumed screen for content allows for a determination of whether depth adjustment is necessary, based on a comparison of the size of the assumed screen for content with the display screen size stored in the display device property saving module 16. The depth adjustment determination module 17 thus makes the determination of whether depth adjustment is necessary for a content based on the information stored in the display device property saving module 16 and on the information stored in the playback content property saving module 7.

4. User Input

The constituent element classified into the “user input” group is the UO detection module 18.

UO Detection Module 18

The UO detection module 18 is, for example, the portion that receives the signal corresponding to an instruction the user makes by operating the remote control or the like. With the UO detection module, it is possible for example to receive signals corresponding to real-time instructions for the depth of stereoscopic video images input via key operation, or to receive signals corresponding to adjustments of device settings (including depth adjustment settings).

When detecting a request to play back stereoscopic video images via user operation of the remote control, the UO detection module 18 may forward the request to play back stereoscopic video images to the group of constituent elements corresponding to the playback unit. A running application may also transmit a request for playback of stereoscopic video images.

The case of a running application requesting playback of stereoscopic video images refers to when, for example, an application startup menu starts up a bytecode application, such as a Java application, and the started-up application transmits a request for playback of stereoscopic video images, corresponding to a user operation detected by the UO detection module 18, to the group of constituent elements corresponding to the playback unit. The request for playback of stereoscopic video images includes information on the location for acquiring the content to be played back, and whether the image content is monoscopic or stereoscopic.

5. Inter-device Communication

The following describes the constituent elements classified into the “inter-device communication” group. The constituent elements classified into the “inter-device communication” group are the device interface 19, the parser 20, the communications control unit 21, the capability information storage module 22, the communications information creation module 23, the capability comparison module 24, and the response information creation module 25. The following describes these constituent elements.

Device Interface 19

The inter-device interface 19 transfers decoded video images and audio over, for example, a multimedia cable, a composite cable, or a component cable that complies with the HDMI standard. In particular, HDMI allows for addition of a variety of property information to video images. When using a multimedia cable interface in the inter-device interface 19 instead of the network interface 1, information on the capabilities of the device that is to perform display processing is stored in the display device property saving module 6 via the multimedia cable interface.

Parser 20

The parser 20 parses data for inter-device negotiation and converts information created by a transmission information creation module 9 or a response information creation module 12 into data that can be processed by the device.

Communications Control Unit 21

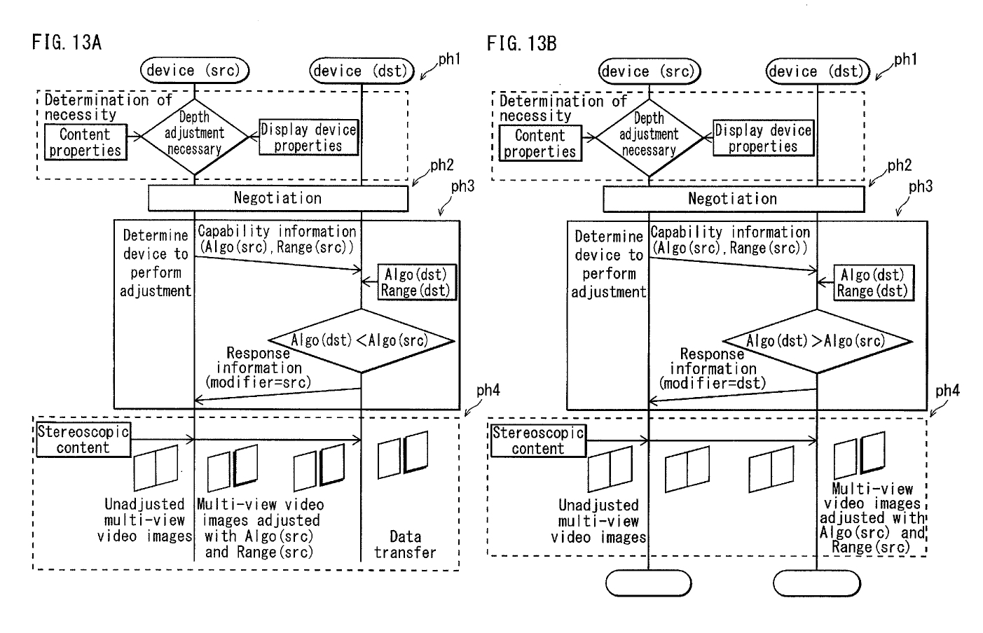

The communications control unit 21 performs communications control in the video processing device. The communications control unit 21 serves no purpose alone, only achieving its true usefulness during a communications sequence in which devices with the same structure connect and exchange messages and data. The following describes the communications sequence between devices. FIG. 13A illustrates a communications sequence performed by the communications control unit 21.

The left side shows the source, and the right side shows the destination.

Along the vertical direction is a time axis shared by a plurality of devices. This figure illustrates a phase ph1 for determining the necessity of depth adjustment, a negotiation phase ph2, a phase ph3 for determining which device is to perform depth adjustment based on the capability information, and a phase ph4 for transferring the left-view image data and the right-view image data that constitute a stereoscopic content. Two variations on the determination phase ph3 to determine the depth adjustment performing device and on the transfer phase ph4 exist based on differences in search algorithm capability. The two sequences shown respectively in FIG. 13A and 13B illustrate these variations. FIG. 13A is the case when the source has a higher capability, and FIG. 13B is the case when the destination has a higher search capability.

FIG. 13A illustrates the case when the algorithm capability (Algo(dst)) at the receiving end is higher than the algorithm capability (Algo(src)) at the transmitting end, and FIG. 13B illustrates the reverse case. This difference is also clear from the content of the determining phase to determine the depth adjustment performing device. In other words, the inequality between the level of the search algorithm for the source (Algo(src)) and the level of the search algorithm for the destination (Algo(dst)) is reversed between FIGS. 13A and 13B. This difference also appears in the transfer phase. In the transfer phase, the parallelograms in a horizontal line represent the left-view images and the right-view images constituting the stereoscopic view. Among the left-view images and the right-view images, those represented by parallelograms with a narrow gap therebetween have not been adjusted for depth, whereas those represented by parallelograms with a wide gap have been adjusted. In FIG. 13A, depth adjustment is performed at the transmitting end, whereas in FIG. 13B, depth adjustment is performed at the receiving end. The reason this difference occurs is that in FIG. 13A, it is assumed that the destination has a higher depth adjustment capability, whereas in FIG. 13B, it is assumed that the source has a higher depth adjustment capability. It is clear that in the above determining phase, the depth adjustment performing device switches between the source and the destination based on whether the source or the destination has the higher capability. This concludes the description of the communications control unit 21.

Capability Information Storage Module 22

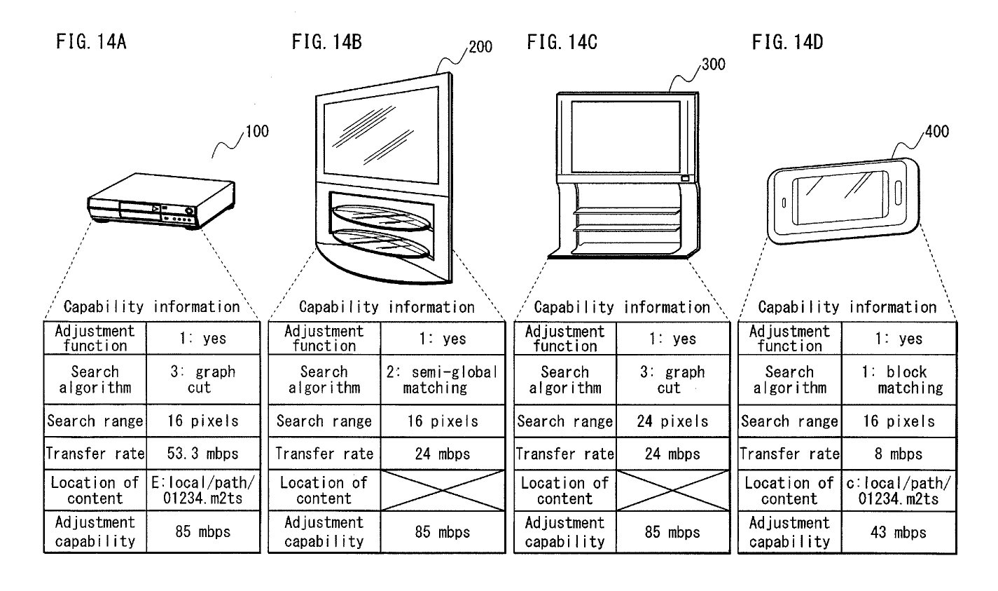

The capability information storage module 22 stores capability information properties describing the device's capability for depth adjustment. Since the capability information indicates the depth adjustment capability of each device, the value that is set differs for each device. FIGS. 14A through 14D illustrate example settings of capability information for the playback device 100, the television 200, the television 300, and the mobile terminal 400 illustrated in FIG. 1. Each piece of capability information in FIGS. 14A through 14D includes the following elements: absence/presence of an adjustment function, the search algorithm, the search range, the transfer rate; the location of the target playback content, and the adjustment capability. The following describes these elements of the capability information. Example settings of the values to which the above elements are set are also described.

“Absence/presence of adjustment function” is a property embedded in the device in advance and is information on whether the device has a function to convert depth. In the examples illustrated in FIGS. 14A through 14D, the playback device 100, the television 200, the television 300, and the mobile terminal 400 all have a depth adjustment function.

The “search algorithm” is a property embedded in the device in advance and stores a variable associated with the name of the algorithm for implementing the depth conversion function of the device. In FIGS. 14A through 14D, the search algorithm for the playback device 100 and the television 300 is a graph cut. On the other hand, the search algorithm for the television 200 is semi-global matching, and the search algorithm for the mobile terminal 400 is block matching. The devices are not restricted to having only one algorithm and may instead have a plurality. In this case, a plurality of different values are set as the property for the depth adjustment algorithm.

The “search range” is a property embedded in the device in advance. The search range indicates, for example, a default parameter when using the algorithm set as the search algorithm. The algorithm parameter is, for example, the range in pixels for searching horizontally when obtaining parallax information on the left and right views. In the examples in FIGS. 14A through 14D, the search range of the television 300 is set to 24 pixels, and the search range of the playback device 100, the television 300, and the television 200 is set to 16 pixels.

The “transfer rate” is a value indicating the throughput of the interface in a connection with another device. The data transfer capability within the depth adjustment capability properties is provided for discernment of whether transfer by the other device during data exchange is wired HDMI or wireless Wifi. The transfer rate may be a property embedded in the device in advance, or the throughput during negotiations may be measured and the measured value then used. In the examples in FIGS. 14A through 14D, the transfer rate is set at 53.3 Mbps in the playback device 100, 24 Mbps in the television 200 and the 300, and 8 Mbps in the mobile terminal 400.

The “location of the target playback content” indicates the file path for the storage medium where the content for playback is saved. In the example in FIG. 14A, the location of the content for playback on the playback device 100 is “Ellocal/path/01234.mt2s”, and in the example in FIG. 14D, the location of the content for playback on the mobile terminal 400 is “Cilocal/path/01234.mt2s”.

The “adjustment capability” is a benchmark score indicating the capability when the search algorithm and the search range are applied to the content for playback. It is desirable that this value take into consideration the data throughput at the location where the content for playback is saved. For example, data saved on a removable medium and on the disc drive 2a is dependent on the device's rate of reading from the medium. Therefore, it is preferable to ascertain the depth adjustment processing capability after attempting depth adjustment once. When a plurality of values is indicated for the search algorithm, the depth adjustment processing capability is indicated for each search algorithm. In the example in FIGS. 14A through 14D, the playback device 100, the television 200, and the television 300 all have an adjustment capability of 85 Mbps. These devices are thus clearly equal. On the other hand, the mobile terminal 400 has an adjustment capability of 43 Mbps, which is clearly a lower adjustment capability.

In sum, the adjustment function property is set to “yes” for all of the devices in FIGS. 14A through 14D. The algorithm is set to a graph cut for both the playback device 100 and the television 300, to semi-global matching for the television 200, and to block matching for the mobile terminal 400. The search range is set to 24 pixels only for the television 300. It is thus clear that the above differences in the capability of each device are reflected in the capability information.

Communications Information Creation Module 23

When a device is the source, the communications information creation module 23 of the device reads the capability information of the device and creates transmission information by converting the capability information into a data format appropriate for transfer to another device.

Capability Comparison Module 24

The capability comparison module 24 compares the search level in the capability information received from another device with the search level of the device provided with the capability comparison module 24 in order to determine, based also on transmission information received from the device that is the target of negotiations, which device is to perform depth adjustment and in what way. The capability comparison module 24 determines whether the source or the destination is to perform depth adjustment by comparing the search algorithm indicated in the capability information transmitted by the source during inter-device connection with the search algorithm indicated in the capability information for the device provided with the capability comparison module 24. The reason for determining the device that performs depth adjustment based on the level of the search algorithm is that differences in the search algorithm greatly influence the accuracy of the matching point search. When the level of the search algorithm is the same for both devices, the device that performs depth adjustment is determined by the extent of the search range. When the search range is the same for both devices, the device that performs depth adjustment is determined by the rate of depth adjustment by the two devices. In the above way, the search algorithms for two connected devices are compared, and when the levels are equal, a different parameter of the devices is compared, such as the extent of the search range or the rate of depth adjustment. This reflects the product concept of not simply comparing the rate of depth adjustment, but of determining the device that performs depth adjustment based on a comparison of quality.

Response Information Creation Module 25

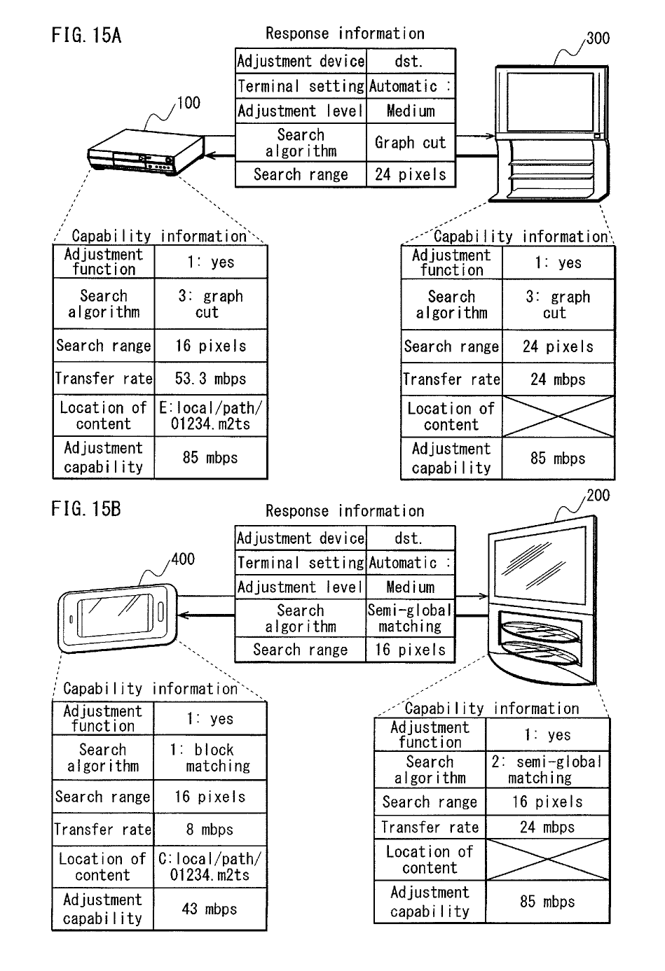

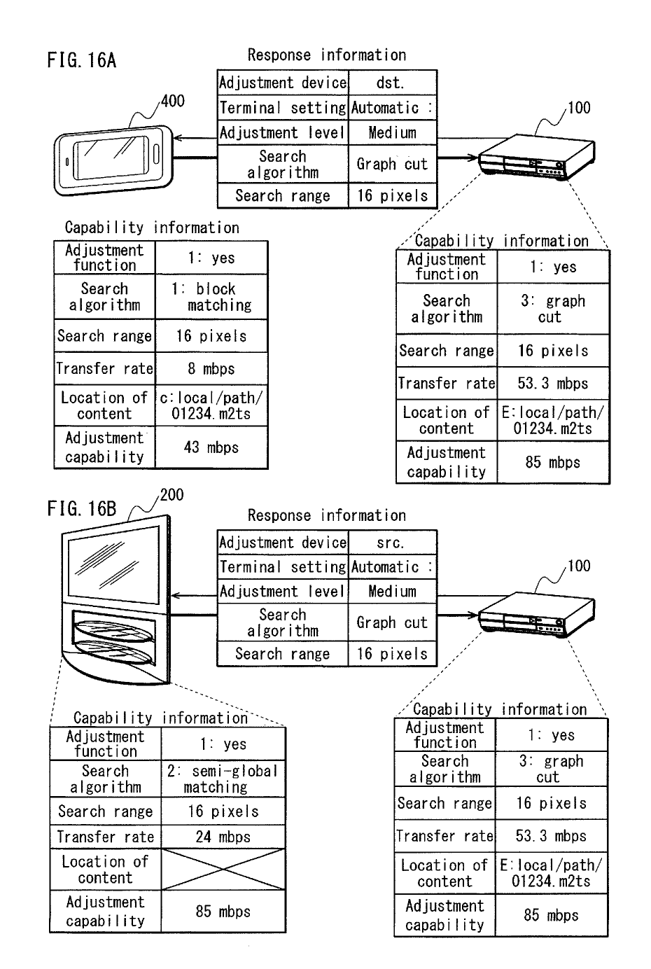

The response information creation module 25 creates response information indicating the results of comparison performed by the capability information storage module 22 and transmits the response information to the source. The following describes what type of response information is transmitted when devices are connected under the assumption that the capability information of each device is set as illustrated in FIGS. 14A through 14D. FIG. 15A illustrates the response information transmitted by the television 300 when the playback device 100 and the television 300 are connected. FIG. 15B illustrates the response information transmitted by the television 200 when the mobile terminal 400 and the television 200 are connected. FIG. 16A illustrates the response information transmitted by the mobile terminal 400 when the mobile terminal 400 and the playback device 100 are connected. FIG. 16B illustrates the response information transmitted by the television 200 when the television 200 and the playback device 100 are connected. The following describes the data structure common to the response information in each of these figures. The response information includes the following information fields: an adjustment device, a terminal function, an adjustment level, a search algorithm, and a search range.

The “adjustment device” indicates the result of determining which device is to perform adjustment, the source or the destination. In the response information in the connection patterns in FIGS. 15A, 15B, and 16A, the adjustment device is the destination (dst). The reason why the adjustment device is set to the destination is that a comparison of the capability information for the connection patterns in FIGS. 15A, 15B, and 16A indicated that the destination has a higher capability. In the response information in the connection pattern of FIG. 16B, the source (src) is the adjustment device. The reason why the adjustment device is set to the source is that a comparison of the capability information for the connection pattern in FIG. 16B indicated that the source has a higher capability.

The “terminal function” indicates whether the depth adjustment is performed automatically or manually. In all of the connection patterns in FIGS. 15A, 15B, 16A, and 16B, the terminal function is set to automatic.

The “adjustment level” indicates the level to which the jump-forward amount is set: high, medium, or low. In all of the connection patterns in FIGS. 15A, 15B, 16A, and 16B, the adjustment level is set to “medium”.

The “search algorithm” indicates the algorithm used by the device that performs depth adjustment. The algorithm is set to a graph cut in FIG. 15A and to semi-global matching in FIG. 15B. The algorithm is set to a graph cut in FIGS. 16A and 16B.

The “search range” indicates the range over which the device performing depth adjustment searches for matching points. Within the response information in the connection patterns illustrated in FIGS. 15B, 16A, and 16B, the search range is set to 16 pixels. Within the response information in the connection pattern illustrated in FIG. 16A, the search range is set to 24 pixels.

In sum, it is clear that in the connection patterns, the other device is notified, via the response information, of which device has the higher adjustment capability, the source or the destination. In FIG. 15A, the algorithms are the same, but since the search range is wider for the television 300, the television 300 is chosen as the adjustment device. Accordingly, the playback device 100 transmits left-view image data and right-view image data that has been adjusted for depth to the television 300. The television 300 then performs depth adjustment using its own algorithm.

6. Screen Adaptation

The constituent element classified into the “screen adaptation” group is the output video image converter 26. The following describes this constituent element.

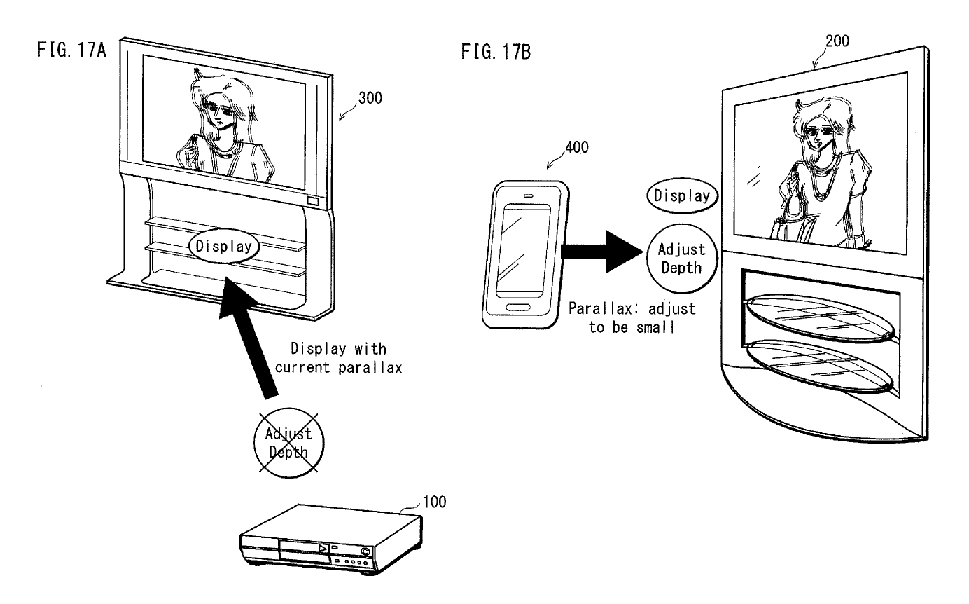

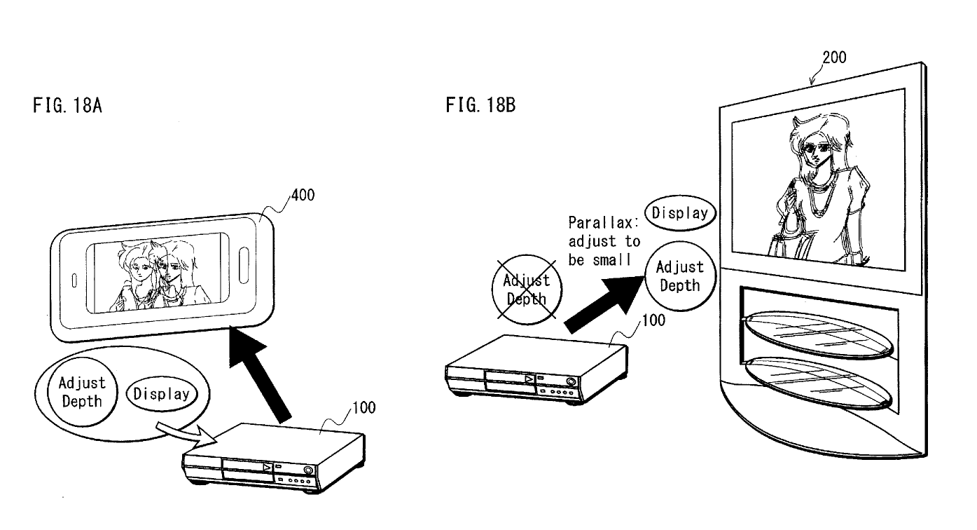

Based on the response information, the output video image converter 26 determines the format for transmission of stereoscopic video content to a device with which negotiations are performed and converts uncompressed left-view image data and right-view image data into the determined format. Various patterns are possible, such as transmission after conversion to a format that allows the device with which negotiations are performed to process decoded data for which depth has been adjusted, or a pattern in which the device itself receives decoded stereoscopic video image data, performs depth adjustment, and displays the data. The following describes the display by the television 200, the television 300, and the mobile terminal 400 after the output video image converter 13 converts the format when the destination transmits, to the source, the response information illustrated in FIGS. 15A, 15B, 16A, and 16B. FIGS. 17A, 17B, 18A, and 18B illustrate a plurality of source-destination patterns and the stereoscopic display for each pattern.

FIG. 17A illustrates connection between the television 300 and the playback device 100. The search algorithms for the playback device 100 and the television 300 are the same, but since the search range is wider for the television 300, the television 300 is chosen as the adjustment device. Accordingly, the playback device 100 transmits left-view image data and right-view image data that has not been adjusted for depth to the television 300. The television 300 then performs depth adjustment using its own algorithm.

FIG. 17B illustrates connection between the mobile terminal 400 and the television 200. During connection between the mobile terminal 400 and the television 200, the television 200 performs the depth adjustment, since the television 200 can perform a matching point search with semi-global matching. In this case, the left and right-view images are output to the destination without adjustment, since the television 200 is the destination. The television 200 then performs depth adjustment by semi-global matching, so that stereoscopic playback is performed with the jump-forward amount set to a low level.

FIG. 18A illustrates connection between the mobile terminal 400 and the playback device 100. During connection between the mobile terminal 400 and the playback device 100, the playback device 100 performs the depth adjustment, since the playback device 100 can perform a matching point search with a graph cut. In this case, the left and right-view images are output to the destination after adjustment by the source, since the mobile terminal 400 is the source. The playback device 100 then performs depth adjustment by a graph cut, so that stereoscopic playback is performed with the jump-forward amount set to a high level.

FIG. 18A illustrates connection between the playback device 100 and the television 200. During connection between the television 200 and the playback device 100, the television 300 performs the depth adjustment, since the television 300 can perform a matching point search with a graph cut. In this case, the left and right-view images are output to the destination without adjustment, since the television 200 is the destination. The television 200 then performs depth adjustment by a graph cut, so that stereoscopic playback is performed with the jump-forward amount set to a medium level.

This concludes the description of the screen adaptation group. Next, a constituent element particular to the display device is described. This particular constituent element is the display unit 25.

Display Unit 26

The display unit 26 receives left-view images and right-view images on which the device provided with the display unit 26 has performed depth adjustment and format conversion. The display unit 26 then displays the video images on the screen. The display unit 26 also receives left-view images and right-view images on which another device has performed depth adjustment and format conversion and displays the video images on the screen.

The video processing device of the present embodiment can be industrially manufactured by implementing each of the above-described constituent elements in the video processing device as a hardware integrated device, such as an ASIC. When using a general-purpose computer architecture, such as a CPU, code ROM, and RAM, for the hardware integrated device, a program containing computer code for the processing steps of the above-described constituent elements needs to be embedded on a code RAM, and the CPU in the hardware integrated device needs to be caused to execute the processing steps of the program. The following describes the processing steps necessary for software implementation when using a general-purpose computer system architecture.

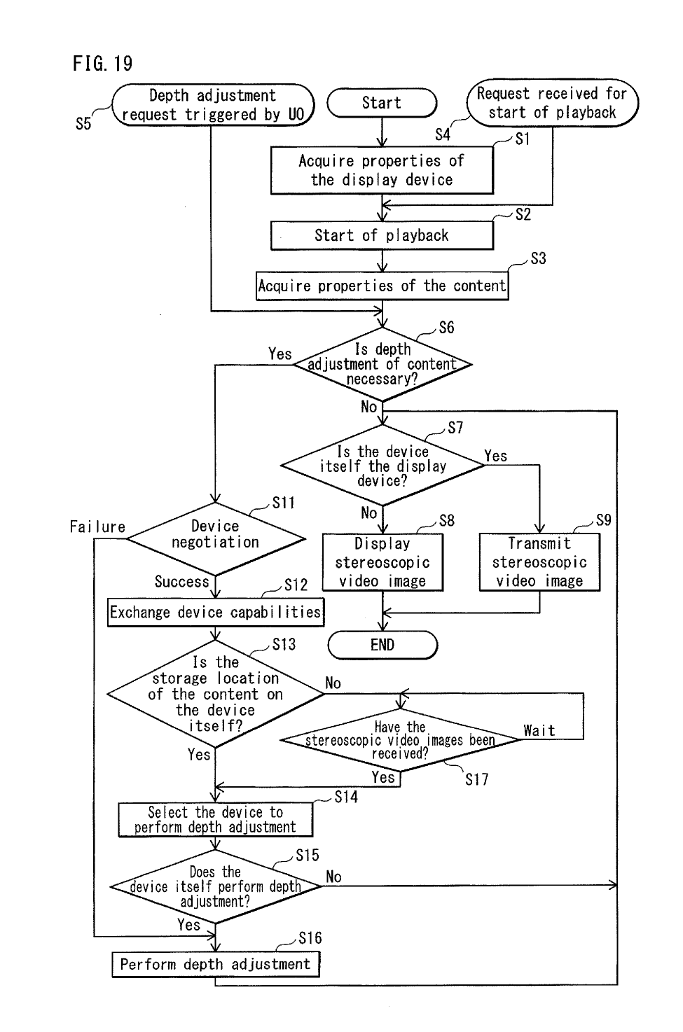

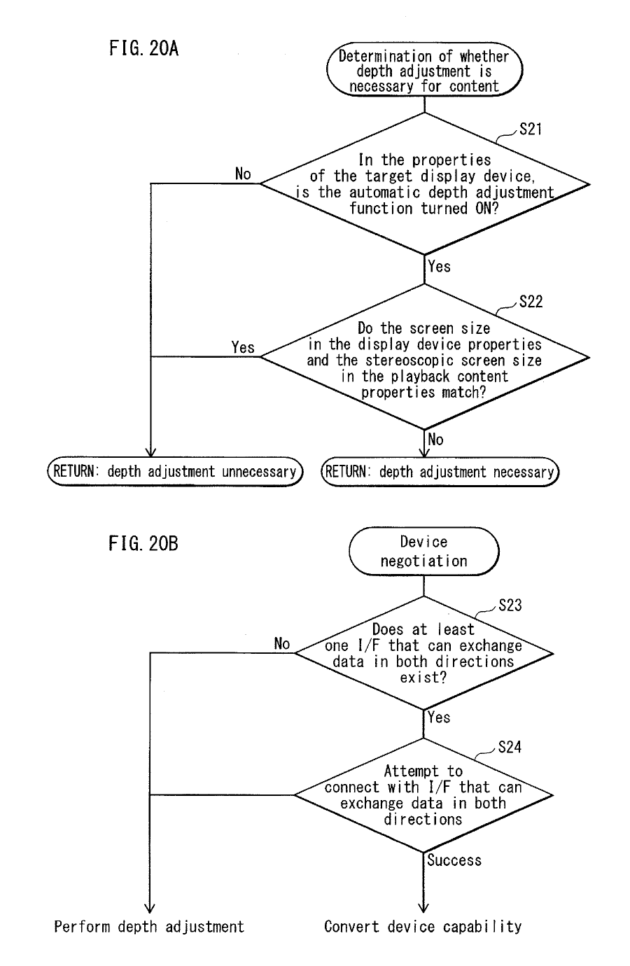

FIG. 19 is a main flowchart of processing steps for depth device determination. The flowchart corresponds to the most significant processing, i.e. the main routine. Flowcharts subordinate to the main flowchart are illustrated in FIGS. 20 through 24. The following describes processing steps of the main routine.

The depth adjustment method for stereoscopic video images may include processing by two or more devices. The processing in FIG. 7, however, illustrates the overall processing by the device that triggers playback of stereoscopic video images, i.e. the client device.

FIG. 19 is a main flow of processing steps by the video processing device. In this flowchart, properties of a display device are acquired (step S1), playback begins (step S2), properties of a content are acquired (step S3), and then processing proceeds to the determination in step S6. When the user requests to begin playback (step S4), step Si is skipped, and processing begins with step S2. When a user operation (UO) requesting depth adjustment is initiated (step S5), steps S1 through S3 are skipped, and processing begins with step S6.

The determination in step S6 is to determine whether depth adjustment is necessary for the content. If depth adjustment is not necessary, steps S7 through S9 are performed. Step S7 is a determination of whether the device itself is the display device. If so, the device displays stereoscopic video images (step S8). If the device is not the display device, the device transmits the stereoscopic video image content to display device, i.e. the other device with which the device exchanges data (step S9).

When determining in step S6 that depth adjustment is necessary, the processing from step S11 through step S17 is performed. These steps are for negotiation between devices (step S11), exchange of device capabilities when negotiation is successful (step S12), and determination in step S13 of whether the storage location of the content is on the device itself.

If the storage location is on device itself, then in step S14 the device to perform depth adjustment is selected. If the storage location is not on the device itself, then in step S17 the device waits to receive the stereoscopic video image content. After receipt, the device to perform depth adjustment is selected in step S14.

In step S15, it is determined whether the device itself is the selected device. If the device itself is the depth adjustment performing device, then the device performs depth adjustment in step S16, and processing proceeds to steps S8 through S10. If the device itself is the display device, the device then displays the stereoscopic video images.

If the device itself is not the depth adjustment performing device, then step S16 is skipped, and processing proceeds to steps S8 through S10. If the device itself is the display device, the device then displays the stereoscopic video images.

FIGS. 20A and 20B are flowcharts illustrating processing steps for the determination of whether depth adjustment is necessary for content and the processing steps for device negotiations. FIG. 20A illustrates processing for determining whether depth adjustment is necessary for content. The flowchart in FIG. 20A is a sub-routine. Upon completion, the sub-routine passes a return value to the flowchart that called the sub-routine. The return values are as illustrated at the bottom of the flowchart.

In step S21, it is determined whether the automatic depth adjustment function is turned ON in the display device properties. In step S22, it is determined whether depth adjustment is necessary by determining whether the screen size in the display device properties matches the stereoscopic screen size in the playback content properties. Step S22 also accounts for the current level of depth adjustment. For example, this step may be implemented by determining whether the parallax detected during a matching point search for a matching point whose depth has been adjusted is larger than a reference value that the device has pre-stored. If the result of both step S21 and step S22 is Yes, the sub-routine returns a value indicating that depth adjustment is necessary. If the result of either step S21 or step S22 is No, the sub-routine returns a value indicating that depth adjustment is not necessary.

FIG. 20B is a flowchart illustrating an example of detailed processing for device negotiation.

In step S23, it is determined whether at least one interface that can exchange data in both directions exists. This interface is the above-described network interface 1. A method of using the network interface 1 is, for example, a communications method using Bluetooth or HTTP protocol, or a method using a combination thereof. The interface supported by the destination device is determined using the information in the target display device property storage module 6.

In step S24, connection is attempted with an interface that can support data exchange in both directions. Next, the stereoscopic video image playback engine 15 confirms connection to the other device. Connection to the other device is, for example, performed with Bluetooth or HTTP protocol when using the network interface 1 to negotiate, and in this case, the success of connection to the other device is confirmed. When using the multimedia cable interface 4 to negotiate, the physical connection is confirmed. If step S23 and step S24 are both Yes, processing proceeds to an exchange of device capability. If either step S23 or step S24 is No, processing proceeds to depth adjustment.

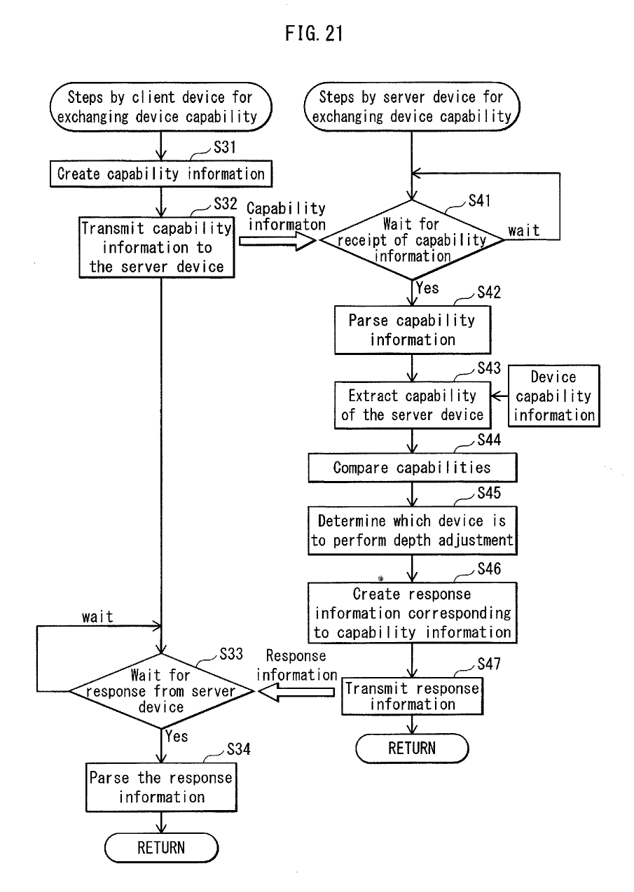

FIG. 21 is a flowchart illustrating steps for exchanging device capability. The source performs the processing steps of creating capability information (step S31), transmitting the capability information to the receiver (step S32), entering a state of waiting for a response from the destination (step S33), and parsing the response information once received (step S34).

The destination performs the processing steps of entering a state of waiting for reception of capability information in step S41, parsing the capability information upon receipt thereof (step S42), extracting the capability information of the destination device (step S43), subsequently comparing the capability information of the destination device with the received capability information (step S44), determining which device is to perform depth adjustment based on the result of the comparison (step S45), creating response information corresponding to the capability information (step S46), and transmitting the corresponding information (step S47). p Selection of Device to Perform Depth Adjustment

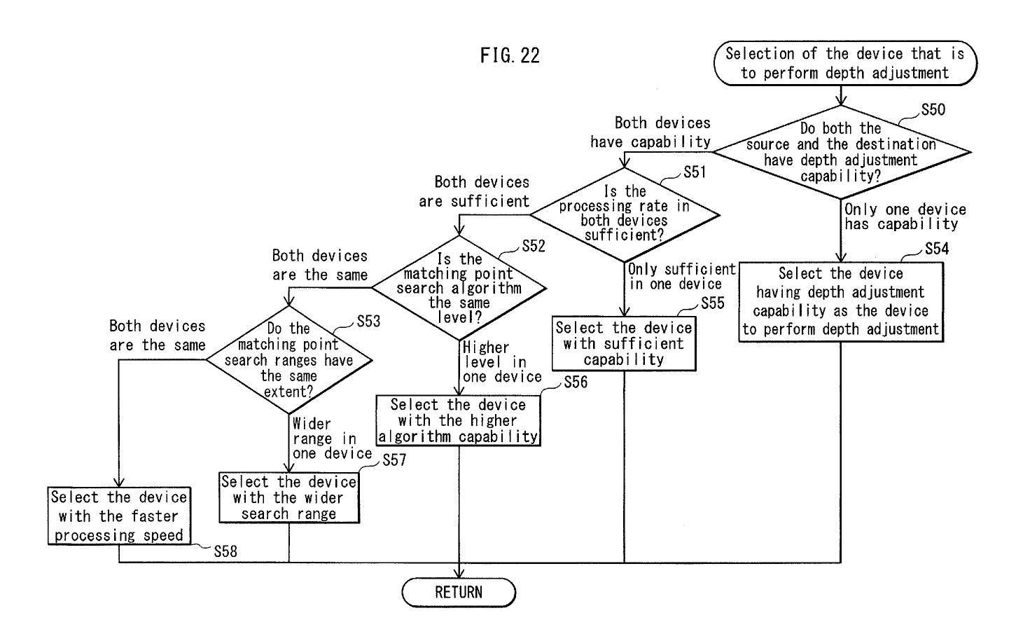

FIG. 22 is a flowchart illustrating steps for selecting the device that is to perform depth adjustment. This flowchart is composed of determination steps S50 through S53. The determination results differ if the result of any one of these determination steps is Yes.

Step S50 is a determination of whether both the source and the destination have depth adjustment, and step S51 is a determination of whether the generation rate of the depth image in both devices is sufficient. Step S52 is a determination of whether the capability of the search algorithm in both devices is the same, and step S52 is a determination of whether the matching point search range is the same in both devices. If only one of the source and the destination has a depth adjustment ability, then in step S54, the device that has the depth adjustment ability performs the depth adjustment. If both devices have depth adjustment ability, then in step S51, it is determined whether the matching point search processing speed is sufficient in both devices. If the processing speed in one of the devices exceeds a predetermined threshold, then in step S55, the device that can perform the matching point search at the processing speed exceeding the threshold is selected.

When the matching point search processing speed of both devices exceeds the threshold, then in step S52, the level of the search algorithm is compared. If the level of the search algorithm in one of the devices is higher, then in step S56, the device with the higher level search algorithm is selected.

If the level of the search algorithm is the same in both devices, the search ranges are compared in step S53. If the search range is wider in one of the devices, then in step S57, the device with the wider search range is selected as the device to perform the depth adjustment.

If the search range is the same for both devices, then in step S58, the device with a faster matching search processing speed is selected as the device to perform the depth adjustment. If the matching search processing speed is the same for both devices, then the device for display is selected as the device to perform the depth adjustment.

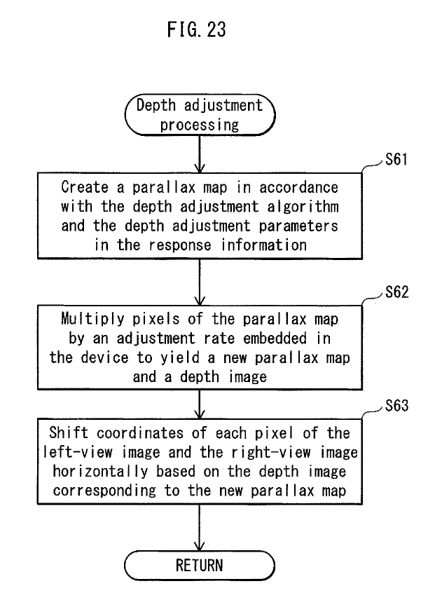

FIG. 23 is a flowchart illustrating processing steps for the depth adjustment. As described above, the depth adjustment processing is performed by first generating a parallax map by parallax calculation, such as the block matching of Non-Patent Literature 1 or the graph cut of Non-Patent Literature 2. The device that is to perform the depth adjustment then multiplies each pixel in the parallax map by a pre-stored adjustment rate (such as ½), yielding a new parallax map. Each pixel in the left-view image and the right-view image is then shifted horizontally based on a depth map that corresponds to the parallax map.

In step S61, the parallax map is generated in accordance with the depth adjustment algorithm and the depth adjustment parameters in the response information, and in step S62, the pixels of the parallax map are multiplied by an adjustment rate embedded in the device to yield a new parallax map and a depth image. In step S63, each pixel of the left-view image and the right-view image is shifted horizontally based on the depth image corresponding to the new parallax map.

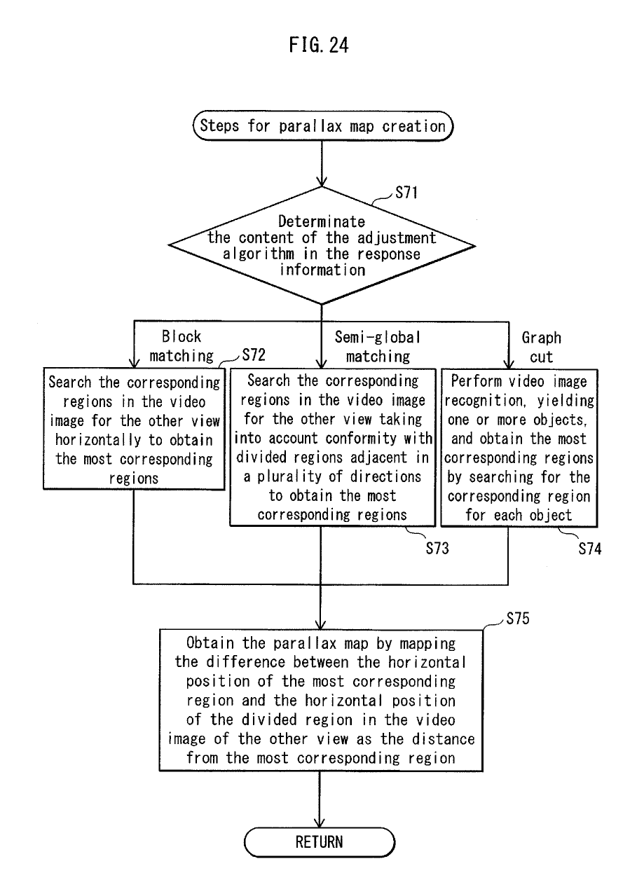

FIG. 24 is a flowchart illustrating processing steps for parallax map creation. Step S71 is a determination of the content of the adjustment algorithm in the response information. If the algorithm is block matching, then in step S72, the corresponding regions in the video image for the other view are searched for horizontally to obtain the most corresponding regions.

If the algorithm is semi-global matching, then in step S73, the corresponding regions in the video image for the other view are searched for taking into account conformity with divided regions adjacent in a plurality of directions to obtain the most corresponding regions.

If the algorithm is a graph cut, then in step S74, the video image is divided up by object, and the most corresponding regions are obtained by searching for the most corresponding region for each divided region.

In step S75, the parallax map is obtained by mapping the difference between the horizontal position of the most corresponding region and the horizontal position of the divided region in the video image of the other view as the distance from the most corresponding region.

### Embodiment 2

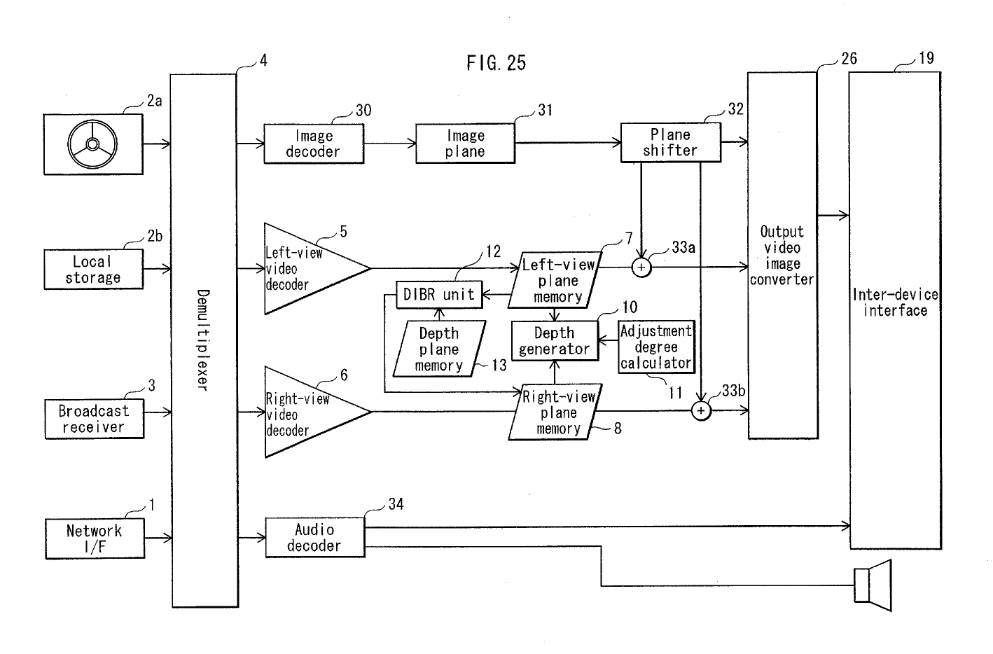

The stream targeted for playback in Embodiment 1 has been described as limited to one type of video stream. By contrast, in the present embodiment, an internal structure is adopted taking into consideration data other than a video stream. FIG. 25 illustrates the internal structure that takes into consideration data other than a video stream. As illustrated in FIG. 25, the video processing device of Embodiment 2 additionally includes an image decoder 30, an image memory 31, a shift unit 32, combining units 33a and 33b, and an audio decoder 34.

The image decoder 30 obtains uncompressed graphics by decoding graphics data such as JPG/PNG demultiplexed by the demultiplexer 4.

The image memory 31 stores the uncompressed graphics obtained by decoding.

The shift unit 32 obtains a left-view image and a right-view image by performing a plane shift using a preset offset. The plane shift is a technique disclosed in Patent Literature 1. The entire screen is shifted during the plane shift, thus identically changing the depth of all objects in the video image. As a result, the stereoscopic impression of the video image does not change, but rather the display position of the stereoscopic video image is adjusted to appear closer towards the viewer or further back.

The combining unit 33a combines the left-view image output by the left-view image decoder 5 with the left-view image generated by the shift unit 32.

The combining unit 33b combines the right-view image output by the right-view image decoder 6 with the right-view image generated by the shift unit 32.

The audio decoder 34 decodes audio frames output by the demultiplexer 4 and outputs audio data in uncompressed format.

In the above structure, the combined images resulting from combining graphics with the left-view image and with the right-view image may be the target of depth adjustment. If these graphics represent a GUI, the depth of the GUI may also be adjusted appropriately.

As described above, the shift unit 32 performs a plane shift by using a preset offset. Therefore, in the present embodiment, the degree to which images jump forward is controlled by increasing or decreasing this offset.

As described above, with the present embodiment, an increase or decrease is applied to graphics combined with images in accordance with the screen size of the display device, so as to appropriately adjust the jump-forward amount of the images and the graphics.

Notes

While the best mode known by the applicant at the time of filing of the application has been described, further improvements or changes in the following technical areas may be made. It should be noted that the choice between implementation as described in the embodiments and adoption of the following improvements or changes is an entirely subjective decision left up to the practitioner.

Acquisition of Properties

The properties of the display device may be acquired during device negotiation.

Depth Adjustment by a Third Device

When two devices are connected and neither device has depth adjustment, it is desirable to have a third device perform depth adjustment. When only one candidate third device exists, that device is caused to perform depth adjustment. On the other hand, when multiple candidate third devices exist, it is desirable to select one of the candidates as the device to perform depth adjustment. The determination of the device to perform the depth adjustment should be made while taking back-and-forth time into consideration. In this context, back-and-forth time refers to the time for transferring unadjusted image data to the candidate device and the time for receiving the adjusted image data back from the candidate device. This back-and-forth time is determined by the transfer rate. Therefore, it is possible to determine which candidate device can provide adjusted image data the quickest by comparing transfer rates. Accordingly, it is desirable to determine which of the candidate devices should be the third device by comparing transfer rates.

Variation on Stream Supply Source

In order to implement the stereoscopic video depth adjustment function, it is not necessary to provide all of the following: the network interface 1, the removable media, the BD-ROM drive 3, and the multimedia cable interface 4. If by connecting at least two devices, playback and display of stereoscopic video images as well as acquisition of information on the stereoscopic video images from the source device or the destination device are possible, then it is not necessary for one of the devices to have all of the network interface 1, the removable media, the BD-ROM drive 3, and the multimedia cable interface 4. Alternatively, only the above interfaces that are necessary for acquiring information from an external source may be provided.

In the example described in the present embodiment, stream data including stereoscopic video images is acquired via the network interface 1, the removable media, and the disc drive 2a. Subsequently, the acquired stream data is transmitted via the multimedia cable interface 4, and inter-device negotiation is performed via the network interface. The present invention is not, however, limited in this way.

For example, if devices are connected with the multimedia cable interface 4 using an HDMI connection, then by using an extended partition of the HDMI to perform negotiations, connection need not be made using the network interface.

Furthermore, it is not necessary for the large-size display 400, the medium-size television 300, or the mobile terminal 600 to be provided with the BD-ROM drive 3, for example.

Variation on the Removable Media

The removable media is a means used for exchanging a target playback content between devices. An imagined use case is, for example, to use a removable media as a means for transmitting stereoscopic video images when playing back, on another remote device provided with a small display, content that is for a large display and is stored on an optical disk. If a different means for exchanging stereoscopic video images is provided, the device need not be provided with the removable media.

Variation on the Interface

When using a multimedia cable interface as the method for negotiating stereoscopic video image depth, the network interface 1 need not be provided.

Adoption of Virtual File System

In Embodiment 1, the stream data or the JPG/PNG/etc. stereoscopic video image files have been described as acquired via the network interface 1, the removable media, or the disc drive 2a, but acquisition is not limited in this way. For example, in a device, such as the playback device 200, with a virtual file system (not shown in the figures), information on the stream data or the JPG/PNG/etc. stereoscopic video image files may be acquired from the removable media or the disc drive 2a via the virtual file system.

A virtual file system is a function to virtually combine the BD-ROM 100, hard disk, or removable media so that from the perspective of the requester, information seems to be recorded on only one recording medium.

In order to implement such a virtual file system, the virtual file system may for example store, apart from data on the stereoscopic video images, access conversion information indicating (i) information on data to which access is requested of the virtual file system, including a file path, and (ii) the file path indicating the actual location of the corresponding data to be accessed.

Upon receiving an access request, the virtual file system refers to the access conversion information, converts the target of access to the file path where the requested data exists, and causes the data to be accessed.

With this structure, if the file paths requested of the virtual file system are made to appear as being within one virtually set recording medium, for example, then the requester can request access to data without knowing about the existence of multiple devices such as the removable media, the disk drive, and the like.

The display device may be provided with a stereoscopic adjustment function. Furthermore, in the present embodiment, while a device that requires glasses for stereoscopic viewing has been described, this embodiment may be applied to stereoscopic viewing that is possible without glasses, i.e. with the naked eye.

Variation on Device to Perform Depth Adjustment

The determination of the device to perform depth adjustment in Embodiment 1 is simply an example. If the medium-size television 300 or the mobile terminal 400 have powerful hardware capabilities, then the medium-size television 300 or the mobile terminal 400 may perform depth adjustment if doing so does not impair display of stereoscopic video images.

Embodiment as a Mobile Terminal

A mobile terminal extracts compressed left-view image data and compressed right-view image data from a stereoscopic photograph file and plays back the image data. In this context, the stereoscopic photograph file is an MPO file. An MPO (Multi-picture object) file is a file that can be captured by a Nintendo 3DS, a Fuji Film FinePix REAL 3D W1, or a W3 camera and includes the shooting date, size, compressed left-view image, and compressed right-view image. The MPO file also includes geographical information on the location of shooting in the form of geographical latitude, longitude, elevation, bearing, and gradient. The compressed left-view image and compressed right-view image are data compressed in JPEG format. Accordingly, the mobile terminal 400 acquires the right-view image and the left-view image by decompressing JPEG data.

Embodiment as a BD-ROM Playback Device

The read unit reads a stereoscopic interleaved stream file from a recording medium. When reading the stereoscopic interleaved stream file, the read unit uses extent start point information in clip-base information and extent start point information in clip-dependent information of the 3D stream information file to separate the stereoscopic interleaved stream file into a main TS and a sub TS, storing each in a different read buffer. This separation is performed by repeating the following processes: extracting a number of source packets from the stereoscopic interleaved stream file equal to the source packet number indicated by the extent start point information in the clip-dependent information and adding the extracted source packets to the main TS, and then extracting a number of source packets from the stereoscopic interleaved stream file equal to the source packet number indicated by the extent start point information in the clip-base information and adding the extracted source packets to the sub TS.

Both the left-view image decoder 5 and the right-view image decoder 6 are provided with a coded data buffer and a decoded data buffer. After preloading, into the coded data buffer, the view components constituting the dependent-view video stream, the left-view image decoder 5 and the right-view image decoder 6 decode the view component of the picture type (IDR type) that represents a decoder refresh, this view component being located at the top of a closed GOP in the base-view video stream. For this decoding, the coded data buffer and the decoded data buffer are cleared. After thus decoding the IDR type view component, the left-view image decoder 5 and the right-view image decoder 6 decode the subsequent view component in the base-view video stream, which is compressed and encoded based on correlation with the previous view component, and also decode the view component of the dependent-view video stream. Once uncompressed picture data for the view component is obtained by decoding, the picture data is stored in the decoded data buffer and set to be a reference picture.

Using this reference picture, the left-view image decoder 5 and the right-view image decoder 6 perform motion compensation on the subsequent view component in the base-view video stream and on the view component of the dependent-view video stream. Once uncompressed picture data is obtained by performing motion compensation on the subsequent view component in the base-view video stream and the view component of the dependent-view video stream, these pieces of picture data are stored in the decoded data buffer as reference pictures. The above decoding is performed upon reaching the decode start time indicated in the decode time stamp of each access unit.

Configuration as a Television Broadcast Reception Device

To configure the display device as a television broadcast reception device, it is necessary to further provide the display device with a service accepting unit, a reception unit, a separation unit, and a display determination unit.

The service accepting unit manages service selection. Specifically, the service accepting unit accepts a request to change service, as indicated by an application or by the user via a remote control signal, and notifies the reception unit.

The reception unit receives, via an antenna or a cable, signals at a carrier frequency of the transport stream distributed by the selected service and demodulates the transport stream. The reception unit then transmits the demodulated TS to the separation unit.

The reception unit includes a tuner unit, a demodulation unit, and a transport decoder. The tuner unit performs IQ detection on the received broadcast waves. The demodulation unit performs QPSK demodulation, VSB demodulation, and QAM demodulation on the broadcast waves detected by IQ detection.

The demultiplexer extracts system packets, such as PSI, from the received transport stream. From a PMT packet, which is one of the extracted system packets, the demultiplexer acquires a 3D_system_info_descriptor, a 3D_service_info_descriptor, and a 3D_combi_info_descriptor, notifying the display determination unit of these descriptors.

Upon notification by the demultiplexer, the display determination unit refers to the 3D_system_info_descriptor, the 3D_service_info_descriptor, and the 3D_combi_info_descriptor in order to learn the stream structure of the transport stream. The display determination unit then notifies the demultiplexer of the PID of the TS packets that are to be demultiplexed in the current display mode.

Furthermore, when the stereoscopic playback method is a frame alternating method, the display determination unit refers to the 2D_view_flag in the 3D_system_info_descriptor and to the frame_packing_arrangement_type in the 3D_service_info_descriptor to notify the display processing unit of matters such as whether the left-view images and the right-view images are to be played back by 2D playback, and whether the video stream is in side-by-side format. The display determination unit refers to the 3D_playback_type in the 3D_system_info_descriptor extracted by the demultiplexer to determine the playback format of the received transport stream. If the playback format is a service compatible format, the display determination unit refers to the 2D_independent_flag in the 3D_system_info_descriptor to determine whether the video stream used in 2D playback and the video stream used in 3D playback are shared.

If the value of the 2D_independent_flag is zero, the display determination unit refers to the 3D_combi_info_descriptor to identify the stream structure. If the stream structure of the transport stream is 2D/L+R1+R2, then the 2D/L+R1+R2 stream is decoded to yield a combination of left-view image data and right-view image data.

If the stream structure of the transport stream is 2D/L+R, then the 2D/L+R stream is decoded to yield a combination of left-view image data and right-view image data.

If the value of the 2D_independent_flag is one, the display determination unit refers to the 3D_combi_info_descriptor to identify the stream structure. If the stream structure of the transport stream is MPEG2+MVC(Base)+MVC(Dependent), then the MPEG2+MVC(Base)+MVC(Dependent) stream is decoded to yield a combination of left-view image data and right-view image data.

If the stream structure of the transport stream is MPEG2+AVC+AVC, then the MPEG2+AVC+AVC stream is decoded to yield a combination of left-view image data and right-view image data.

If the playback format is a frame compatible format, the display determination unit refers to the 2D_independent_flag in the 3D_system_info_descriptor to determine whether the video stream used in 2D playback and the video stream used in 3D playback are shared. If the value of the 2D_independent_flag is zero, a 2D/SBS stream is decoded to yield a combination of left-view image data and right-view image data.

If the value of the 2D_independent_flag is one, a 2D+SBS stream is decoded to yield a combination of left-view image data and right-view image data. If the frame_packing_arrangement_type is side-by-side format, then 3D playback is performed by cropping the left-view image and the right-view image that exist side-by-side. If the frame_packing_arrangement_type is not side-by-side format, then the format is identified as top-bottom, and 3D playback is performed by cropping the left-view image and the right-view image that are arranged vertically.

The video stream is decoded in accordance with the stream structure identified through the above determinations, thus yielding the left-view image data and the right-view image data.

Range of Stereoscopic Video Image Content

In the embodiments, the stereoscopic video image content targeted for depth adjustment is content recorded on a variety of packaged media, such as an optical disc or a semiconductor memory card. The recording medium of the present embodiment has been described as an optical disc (an existing readable optical disc such as a BD-ROM or a DVD-ROM) with necessary data recorded thereon in advance, but the recording medium is not limited in this way. For example, stereoscopic video image content that includes data necessary for embodying the present invention and that is distributed by broadcast or over a network may be used.

A terminal device having a function to write to an optical disc (where such a function may be embedded in the playback device or in a device other than the playback device) may be used to record content on a writable optical disc (an existing writable optical disc such as a BD-RE or DVD-RAM), and the present invention may be implemented using the content recorded on the optical disc as the target of depth adjustment.

Using, for example, electronic distribution, the data targeted for depth adjustment may, for example, be distributed data containing all or part (such as update data for data necessary for playback) of data corresponding to the original content recorded on, for example, the recording medium 101 (such as the video stream, audio stream, subtitle data, background images, GUI, application, application management table, or the like), or containing additional content.

An example is now described of recording the data targeted for depth adjustment on an SD memory card as a type of semiconductor memory. When recording distributed data on an SD memory card inserted in a slot provided in the playback device, a request is first issued to a distribution server (not shown in the figures), which stores distribution data, for transmission of the distributed data. At this point, the playback device reads identifying information for uniquely identifying the SD memory card (such as an identification number assigned uniquely to SD memory cards, or more specifically, a serial number or the like of the SD memory card) from the SD memory card. The playback device transmits the read identifying information to the distribution server along with the distribution request.

This identifying information for uniquely indentifying the SD memory card corresponds, for example, to the above-described volume ID.

On the other hand, the necessary data among the distribution data (such as the video stream, the audio stream, and the like) is stored on the distribution server after encryption such that the data can be decrypted using a decryption key (such as a title key).

For example, the distribution server stores a private key and is able to dynamically generate public key information that differs for each unique semiconductor memory card identification number.

Furthermore, the distribution server is able to encrypt the key (title key) necessary for decryption of encrypted data (i.e. the distribution server can generate an encrypted title key).

The generated public key information includes information corresponding to an MKB, volume ID, and encrypted title key, for example. A valid combination of, for example, the semiconductor memory unique identification number, the public key included in public key information described below, and a device key recorded in advance on the playback device, yields the key necessary for decryption (for example, the title key that is obtained by decrypting the encrypted title key based on the device key, the MKB, and the semiconductor memory unique identification number). By thus obtaining the key (title key) that is necessary for decryption, the encrypted data can be decrypted.

Next, the playback device records the received public key information and distribution data in a storage region of the semiconductor memory card inserted in the slot.

The following describes an example of a method for playback by decrypting encrypted data among the data included in the distribution data and the public key information recorded in the storage region of the semiconductor memory card. In the received public key information, a device list is recorded indicating information such as the public key (for example, the above-described MKB and encrypted title key), signature information, the semiconductor memory card unique identification number, and devices that are to be invalidated.

The signature information includes, for example, a hash value of the public key information. The device list is a list, for example, of information on devices that might perform unauthorized playback. This information uniquely identifies devices, or parts or functions (programs) included in device, that might perform unauthorized playback by listing, for example, the device key that is pre-recorded in such a playback device, the identification number of the playback device, or the identification number of a decoder provided in the playback device.

The following describes playback of encrypted data among the distribution data recorded in the storage region of the semiconductor memory card. First, before decrypting data encrypted using the public key, it is checked whether the decryption key should be allowed to function. Specifically, the following is checked.

(1) Whether the semiconductor memory unique identifying information that is included in the public key information matches the unique identification number stored in advance in the semiconductor memory card

(2) Whether a hash value of the public key information calculated by the playback device matches the hash value included in the signature information

(3) Whether, based on the information indicated in the device list included in the public key information, the playback device that is to perform playback might perform unauthorized playback (for example, by checking whether the device key indicated in the device list included in the public key information matches the device key stored in advance in the playback device)

These checks may be performed in any order.

The playback device is controlled not to decrypt encrypted data if, in checks (1) through (3), any of the following is true: the semiconductor memory unique identifying information that is included in the public key information does not match the unique identification number stored in advance in the semiconductor memory, the hash value of the public key information calculated by the playback device does not match the hash value included in the signature information, or the playback device that is to perform playback is determined as possibly performing unauthorized playback.

If the semiconductor memory card unique identifying information that is included in the public key information matches the unique identification number stored in advance in the semiconductor memory card, the hash value of the public key information calculated by the playback device matches the hash value included in the signature information, and the playback device that is to perform playback is determined not to be a playback device that might perform unauthorized playback, then the combination of the semiconductor memory unique identification number, the public key included in public key information, and the device key recorded in advance on the playback device is determined to be valid. Using the key necessary for decryption (the title key that is obtained by decrypting the encrypted title key based on the device key, the MKB, and the semiconductor memory unique identification number), the encrypted data is then decrypted.

For example, when the encrypted data is a video stream and an audio stream, the video decoder decrypts (decodes) the video stream using the above-described key necessary for decryption (the title key obtained by decrypting the encrypted title key) and the audio decoder decrypts (decodes) the audio stream using the above-described key necessary for decryption.

With this structure, if playback devices, parts, functions (programs), and the like that might be used maliciously are known at the time of electronic distribution, then by distributing a device list indicating information for identifying these playback devices, parts, and functions, decryption using the public key information (the public key) can be halted when the playback device is indicated in the device list. Therefore, even if the combination of the semiconductor memory unique identification number, the public key included in public key information, and the device key recorded in advance on the playback device is valid, the encrypted data can be prevented from being decrypted, so as to prevent use of distribution data on an unauthorized device.

It is desirable to adopt a structure whereby the semiconductor memory card unique identifier recorded in advance on the semiconductor memory card is stored in a storage region having high confidentiality. This is because if the unique identification number recorded in advance on the semiconductor memory card (such as, in the case of an SD memory card, the serial number of the like of the SD memory card) is tampered with, illegal copies can easily be made. The reason is as follows: unique identification numbers are allocated to semiconductor memory cards, but if the identification numbers are tampered with so as to be the same, the above check (1) loses its meaning, and a number of illegal copies corresponding to the number of falsified identification numbers can be produced. Accordingly, it is desirable to adopt a structure whereby information such as the semiconductor memory card unique identification number is stored in a storage region having high confidentiality.

This structure may, for example, be implemented as follows. Apart from a storage region for storing regular data (referred to as a first storage region), the semiconductor memory card is provided with a separate storage region (referred to as a second storage region) for storing highly confidential area, such as the semiconductor memory card unique identifier, and is provided with a control circuit for accessing the second storage region. Access to the second storage region is then controlled via the control circuit.

For example, data stored in the second storage region may be encrypted before storage, and the control circuit may have a circuit embedded therein for decrypting the encrypted data. In this structure, when access to second storage region is requested of the control circuit, the control circuit decrypts the encrypted data and returned the decrypted data. The control circuit may also store information on the storage location of data stored in the second storage region, and when access to the data is requested, the control circuit may identify the storage location of the corresponding data and return data read from the identified storage location.

When an application that runs on the playback device and requests recording on the semiconductor memory card using electronic distribution issues an access request to the control circuit via the memory card I/F to access data (such as the semiconductor memory unique identification number) stored in the second storage region, the control circuit receives the request, reads the data stored in the second storage region, and returns the data to the application running on the playback device. A structure may be adopted to request, from the distribution server, distribution of data necessary along with the semiconductor memory card unique identification number and to store the public key information and corresponding distribution data that is received from the distribution server in the first storage region. Furthermore, it is desirable that before an application that runs on the playback device and requests recording on the semiconductor memory card using electronic distribution issues an access request to the control circuit via the memory card I/F to access data (such as the semiconductor memory unique identification number) stored in the second storage region, the application be checked for tampering. The tampering check may, for example, use a digital signature complying with existing X.509 specifications. Access to the distribution data stored in the first storage region of the semiconductor memory card need not be made via a control circuit within the semiconductor memory card.

Embodiment as an Integrated Circuit

Other than mechanistic parts such as the drive unit of the recording medium, the connector to external devices, and the like, parts corresponding to logical circuits and storage devices among the hardware structure of the playback device shown in the embodiments, i.e. the core parts of logical circuits parts, may be integrated as a system LSI. A system LSI is a bare chip mounted on a high-density substrate and packaged. Packaging a plurality of bare chips mounted on a high-density substrate yields a multi-chip module, which appears to be one LSI but includes a plurality of bear chips. Such a multi-chip module is also included in the above system LSI.

Types of packaging include not only a system LSI, but also QFP (Quad Flat Package) and PGA (Pin Grid Array). A QFP is a system LSI with pins attached to all four sides of the package. A PGA is a system LSI with a large number of pins attached on the bottom surface thereof.

These pins serve as a power supply, ground, and interface with other circuits. Since some pins in a system LSI act as an interface, the system LSI connecting other circuits to these pins in the system LSI allows the system LSI to act as the core of the playback device.

Embodiment as a Program

The program shown in the embodiments may be created as follows. First, the software developer writes source programs in a computer language. The source programs implement the flowcharts and the mechanistic constituent elements. When writing the source programs, the software developer obeys the syntax of the programming language, using class structure, variables, array variables, and calls to external functions to implement the flowcharts and the mechanistic constituent elements.

The source programs are provided to a compiler as a file. The compiler translates the source programs to generate object programs.

The translation by the compiler includes the steps of syntactic analysis, optimization, resource allocation, and code generation. During the syntactic analysis step, lexical analysis, syntactic analysis, and semantic analysis of the source programs is performed to convert the source programs into intermediate programs. During the optimization step, the intermediate programs are divided into fundamental blocks, the control flow is analyzed, and the data flow is analyzed. During the resource allocation step, to optimize the programs for the instruction set of the targeted processor, the variables in the intermediate programs are assigned to the registers or memory of the targeted processor. During the code generation step, the intermediate instructions in the intermediate programs are converted into program code to yield object programs.

The object programs generated here are composed of one or more pieces of programs code to cause a computer to perform the steps in the flowcharts and the procedures of the functional constituent elements in the embodiments. The program code here may be of a variety of forms, such as native code on a processor or JAVA™ bytecode. Implementation of the steps in the program code may take a variety of forms. When steps can be implemented using an external function, the call instruction to call the external function is the program code. Furthermore, program code for implementing one step may belong to different object programs. In a RISC processor in which the types of instructions are limited, the steps in the flowcharts may be implemented by combining arithmetic instructions, logical instructions, branch instructions, and the like.

Once the object programs are generated, the programmer runs a linker on them. The linker assigns these object programs and related library programs to memory space, unifying them to generate a load module. It is assumed that a computer will read the load module thus generated. The load module causes the computer to perform the processing steps of the flowcharts and the processing steps of the functional constituent elements. The computer programs may be recorded on a non-transitory computer-readable recording medium and provided to the user.

Feasibility as a Line Scan Circuit

DIBR may be implemented as a line scan circuit. A line scan circuit is a hardware element for converting a collection of pixels (1920×1080), amounting to one screen, that are stored in a frame memory into a digital video image signal by reading the pixels 1920 pixels at a time. The line scan circuit can be implemented by a line pixel memory that can store one line of pixel data, a filter circuit, and a conversion circuit that performs parallel/serial conversion. As described above, DIBR is processing to convert the luminance of each pixel in the depth image into parallax and then to shift pixels. By shifting the coordinates of pixels in one line of a panoramic image read from line memory horizontally by a number of pixels corresponding to the depth of the same line in the depth image for the panoramic image, a view image from a different view that has the depth indicated by the depth image can be created.

### INDUSTRIAL APPLICABILITY

The present invention can be adopted in a playback device that plays back stereoscopic video images or stereoscopic video images acquired from a stream, or in a display device that displays stereoscopic video images or stereoscopic video images.

### REFERENCE SIGNS LIST

1 network interface

19 inter-device interface

18 UO detection module

16 display target device property saving module

15 content property saving module

17 depth adjustment determination module

23 communications information creation module

20 parser

24 capability comparison module

25 response information creation module

100 video image playback device

200 large-size television

300 medium-size television

400 mobile terminal

1. A video processing device for transmission and reception of two or more view components and for depth adjustment of stereoscopic video images constituted by the two or more view components, the video processing device comprising:
an inter-device interface configured to connect to a target device with which to perform the transmission and reception of the two or more view components;
a determination unit configured to determine, through performance of a predetermined communications sequence with the target device, which of the video processing device and the target device is to perform the depth adjustment; and
a processing unit configured to perform the depth adjustment, when the determination unit determines that the video processing device is to perform the depth adjustment, on two or more received view components or on two or more view components to be transmitted, wherein
the depth adjustment includes searching for matching pixels that match pixels in a first view component, the matching pixels being included in a second view component, and detecting parallax between the pixels in the first view component and the matching pixels in the second view component, and
the communications sequence includes a transfer phase for transmission and receipt, between the video processing device and the target device, of capability information indicating a search capability for the matching pixels, and a comparison phase for comparing the search capability of the video processing device and the search capability of the target device.

2. The video processing device of claim 1, wherein
the depth adjustment further includes generating a depth image based on the detected parallax, adjusting the depth image in accordance with a screen on which two or more view components are to be displayed, and performing depth image based rendering, based on the adjusted depth image, on the first view component to obtain two or more view components with an adjusted parallax.

3. The video processing device of claim 1, wherein
the searching for matching pixels in the depth adjustment by each device is one of a plurality of levels including:
a first level indicating performance of image recognition on a view component and treating an object recognized by the image recognition as being composed of the matching pixels; and
a second level indicating searching for the matching pixels by scanning a view component,
the capability information indicates whether a search level to search for matching pixels by each of the video processing device and the target device is the first level or the second level, and
a determination phase of the communications sequence includes determining whether the search level for the video processing device equals the search level for the target device, and for determining, when the levels are not equal, that whichever of the video processing device and the target device has a higher search level is to perform the depth adjustment.

4. The video processing device of claim 3, wherein
during the searching for matching pixels in the depth adjustment, a search range of the video processing device differs from a search range of the target device,
the capability information indicates, in pixels, the search range for the video processing device and for the target device, and
the determination phase of the communications sequence includes determining, if the search level for the video processing device equals the search level for the target device, that whichever of the video processing device and the target device has a wider search range is to perform the depth adjustment.

5. The video processing device of claim 4, wherein
the second level includes a search sub-level to search for the matching pixels by block matching and a search sub-level to search for the matching pixels by semi-global matching, and
the search sub-level to search for the matching pixels by semi-global matching is higher than the search sub-level to search for the matching pixels by block matching.

6. The video processing device of claim 1, wherein
the video processing device is a display device,
the target device is a mobile device provided with a stereoscopic photography unit, and
the two or more view components are left-view photograph data and right-view photograph data obtained by the stereoscopic photography unit.

7. The video processing device of claim 1, wherein
the video processing device is a display device,
the target device is a playback device for playing back stereoscopic video content recorded on a recording medium, and
the two or more view components are obtained by the playback device playing back the stereoscopic video content recorded on the recording medium.

8. The video processing device of claim 1, wherein
the video processing device is a playback device for playing back stereoscopic video content recorded on a recording medium,
the target device is a display device, and
the two or more view components are obtained by the playback device playing back the stereoscopic video content recorded on the recording medium.

9. A system comprising two or more video processing devices, wherein
each video processing device is for transmission and reception of two or more view components and for depth adjustment of stereoscopic video images constituted by the two or more view components,
each video processing device comprises:
an inter-device interface configured to connect to a target device with which to perform the transmission and reception of the two or more view components;
a determination unit configured to determine, through performance of a predetermined communications sequence with the target device, which of the video processing device and the target device is to perform the depth adjustment; and
a processing unit configured to perform the depth adjustment, when the determination unit determines that the video processing device is to perform the depth adjustment, on two or more received view components or on two or more view components to be transmitted,
the depth adjustment includes searching for matching pixels that match pixels in a first view component, the matching pixels being included in a second view component, and detecting parallax between the pixels in the first view component and the matching pixels in the second view component, and
the communications sequence includes a transfer phase for transmission and receipt, between the video processing device and the target device, of capability information indicating a search capability for the matching pixels, and a comparison phase for comparing the search capability of the video processing device and the search capability of the target device.

10. A video processing method for transmission and reception of two or more view components and for depth adjustment of stereoscopic video images constituted by the two or more view components, the video processing method comprising the steps of:
connecting to a target device with which to perform the transmission and reception of the two or more view components;
determining, through performance of a predetermined communications sequence with the target device, which of a source device and the target device is to perform the depth adjustment; and
performing the depth adjustment, when determined in the determination step that the source device is to perform the depth adjustment, on two or more received view components or on two or more view components to be transmitted, wherein
the depth adjustment includes searching for matching pixels that match pixels in a first view component, the matching pixels being included in a second view component, and detecting parallax between the pixels in the first view component and the matching pixels in the second view component, and
the communications sequence includes a transfer phase for transmission and receipt, between the source device and the target device, of capability information indicating a search capability for the matching pixels, and a comparison phase for comparing the search capability of the source device and the search capability of the target device.

11. A video processing program for causing a computer internal to a source device to perform transmission and reception of two or more view components and depth adjustment of stereoscopic video images constituted by the two or more view components, the video processing program comprising the steps of:
connecting to a target device with which to perform the transmission and reception of the two or more view components;
determining, through performance of a predetermined communications sequence with the target device, which of the source device and the target device is to perform the depth adjustment; and
performing the depth adjustment, when determined in the determination step that the source device is to perform the depth adjustment, on two or more received view components or on two or more view components to be transmitted, wherein
the depth adjustment includes searching for matching pixels that match pixels in a first view component, the matching pixels being included in a second view component, and detecting parallax between the pixels in the first view component and the matching pixels in the second view component, and
the communications sequence includes a transfer phase for transmission and receipt, between the source device and the target device, of capability information indicating a search capability for the matching pixels, and a comparison phase for comparing the search capability of the source device and the search capability of the target device.
